(19) United States
(12) Patent Application Publication
(10) Pub. No.: US 2019/0281012 A1
(43) Pub. Date: Sep. 12, 2019

(54) INFORMATION PROCESSING APPARATUS AND INFORMATION PROCESSING APPARATUS MANAGEMENT SYSTEM

(71) Applicant: FUJITSU LIMITED, Kawasaki-shi (JP)

(72) Inventor: Naoyuki NISHIKATA, Machida (JP)

(73) Assignee: FUJITSU LIMITED, Kawasaki-shi (JP)

(21) Appl. No.: 16/279,120

(22) Filed: Feb. 19, 2019

(30) Foreign Application Priority Data
Mar. 9, 2018 (JP) 2018-043276

(51) Int. Cl. H04L 29/12; H04L 29/08; G06F 9/4401

(52) U.S. Cl. CPC H04L 61/2015; H04L 67/42; G06F 9/4416; H04L 67/34

(57) ABSTRACT

An information processing apparatus includes a memory and a processor coupled to the memory. The processor receives a plurality of addresses allocated by a plurality of servers, receives a program from a designated server among the plurality of servers by using an allocated address of the designated server designated by a support apparatus, and executes a process to start a received program.

### CROSS-REFERENCE TO RELATED APPLICATION

This application is based upon and claims the benefit of priority of the prior Japanese Patent Application No. 2018-043276, filed on Mar. 9, 2018, the entire contents of which are incorporated herein by reference.

### FIELD

The embodiments discussed herein are related to an information processing apparatus and an information processing apparatus management system.

### BACKGROUND

A Preboot eXecution Environment (PXE) booting is exemplified as one of the computer booting environments. This is a method of activating a program by a function of a PXE client installed in a network interface card (hereinafter, NIC). The PXE booting enables various processes at the start of a computer by activating the PXE client in the NIC and using the Network Bootstrap Program (NBP) possessed by a networked PXE server. That is, the PXE booting executes, for example, installation of an operating system (OS), firmware update, backup, restoration, and activation of a thin client.

In general, the PXE server includes a dynamic host configuration protocol (DHCP) server and a trivial file transfer protocol (TFTP) server. Alternatively, it may be said that a service by the PXE server includes a service by the DHCP and a service by the TFTP. Here, the DHCP server provides an Internet protocol (IP) address and NBP information. Here, the NBP information is information such as an IP address and a file name of the TFTP server having the NBP. The TFTP server also provides the NBP to a PXE client.

The DHCP server is used for IP address allocation. However, when the DHCP server is used for a PXE booting, the DHCP server also possesses the IP address and file name of the TFTP server that provides the NBP as NBP information for the PXE booting. Therefore, when the DHCP is used for the PXE booting, the DHCP server also provides the NBP information along with the IP address.

The PXE client is a simple program having a function of communicating with the DHCP server, the TFTP server, or the PXE server on a network segment that provides this service, in order to acquire the NBP. In addition, when a file with some volume such as OS installation is used, the file may be prepared in a file transfer protocol (FTP) server that is separate from the PXE server.

Related techniques are disclosed in, for example, Japanese Laid-open Patent Publication Nos. 2002-169694 and 2014-174878, and U.S. Pat. No. 6,871,210.

### SUMMARY

According to an aspect of the embodiments, an information processing apparatus includes a memory and a processor coupled to the memory. The processor receives a plurality of addresses allocated by a plurality of servers, receives a program from a designated server among the plurality of servers by using an allocated address of the designated server designated by a support apparatus, and executes a process to start a received program.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating the configuration of an information system according to a comparative example;

FIG. 2 is a view illustrating a procedure of PXE booting;

FIG. 3 is a view illustrating PXE booting setting and power-on procedure by an administrator;

FIG. 4 is a sequence diagram illustrating a process of PXE booting according to the comparative example;

FIG. 5 is a sequence diagram illustrating a process of PXE booting according to the comparative example;

FIG. 6 is a sequence diagram illustrating a process of PXE booting according to the comparative example;

FIG. 7 is a sequence diagram illustrating a process of PXE booting according to the comparative example;

FIG. 8 is a sequence diagram illustrating a process of PXE booting according to the comparative example;

FIG. 9 is a sequence diagram illustrating a process of PXE booting according to the comparative example;

FIG. 10 is a view illustrating the configuration of an information system according to an embodiment;

FIG. 11 is a view illustrating a hardware configuration of an information processing apparatus according to an embodiment;

FIG. 12 is a sequence diagram illustrating a process of setting PXE at the head of a booting order according to an input operation by an administrator;

FIG. 13 is a sequence diagram illustrating a process of PXE booting according to a first embodiment;

FIGS. 14A and 14B are sequence diagrams illustrating a process of PXE booting according to the first embodiment;

FIG. 15 is a sequence diagram illustrating a process of PXE booting according to the first embodiment;

FIG. 16 is a sequence diagram illustrating a process of PXE booting according to the first embodiment;

FIG. 17 is a sequence diagram illustrating a process of PXE booting according to the first embodiment;

FIG. 18 is a sequence diagram illustrating a process of PXE booting according to the first embodiment;

FIGS. 19A and 19B are sequence diagrams illustrating a process of PXE booting according to the first embodiment;

FIG. 20 is a sequence diagram illustrating a process of PXE booting according to the first embodiment;

FIG. 21 is a view illustrating the configuration of a DHCP Offer list;

FIG. 22 is a view illustrating the configuration of DHCP server selection response information received by an extended PXE client;

FIG. 23 is a view illustrating the configuration of firewall setting information;

FIG. 24 is a view illustrating the configuration of a DHCP selection screen (pre-selection);

FIG. 25 is a view illustrating the configuration of a DHCP server selection screen (post-selection);

FIG. 26 is a view illustrating the configuration of a DHCP message;

FIG. 27 is a view illustrating the detailed configuration of flags;

FIGS. 28A and 28B are sequence diagrams illustrating a PXE booting process according to a second embodiment; and

FIG. 29 is a sequence diagram illustrating a PXE booting process according to the second embodiment.

### DESCRIPTION OF EMBODIMENTS

In order to provide the NBP according to the purpose of a PXE booting, there are some cases where it is desired to arrange plural PXE servers on the same network segment. However, as described above, many products having the PXE server function also include a dedicated DHCP server. This is because the DHCP server also notifies the PXE client of the NBP information for the service provided by the PXE server. That is, since the DHCP server included in the PXE server has information unique to the PXE server, plural DHCP servers are installed in order to operate the plural PXE servers.

Meanwhile, the PXE client cannot select a PXE server. According to the specifications of DHCP, when plural DHCP servers are operated in one network segment, it is possible to select an arbitrary one among plural responses from the plural DHCP servers. However, since the PXE client cannot determine the purpose of its booting by itself, the PXE client cannot select one of the plural responses from the plural DHCP servers. Therefore, in general, the PXE client adopts the response of the DHCP server received for the first time.

To summarize the above, in an environment where plural PXE servers are arranged in the same network segment, plural DHCP servers respond to a DHCP request message (DHCP Discover) broadcast by the PXE client, and the PXE client adopts a response received for the first time (DHCP Offer). Therefore, a DHCP server from which the PXE client is to adopt a response is not determined. The adopted response of the DHCP server may be a simple IP allocation unrelated to the PXE server, and NBP information of services provided by an unintended PXE server may be added thereto. For this reason, the PXE client cannot download the NBP that executes an intended process by the PXE booting, and it may happen that an expected process cannot be performed on a client machine. Even when the PXE client can adopt a response from a DHCP server that happens to match an intended process at the time of acquiring an NBP and can acquire a desired NBP, the same problem may occur at the time of determining a DHCP server after the acquired NBP is started.

In view of the above, in order to arrange plural PXE servers and DHCP servers in the same network segment, it may be conceivable to temporarily stop unintended servers. However, every time PXE booting is performed for each client machine, other services are stopped, which affects the system operation.

Hereinafter, an information system information processing apparatus, an information processing method, and a program according to an embodiment will be described with reference to the accompanying drawings. The configuration of the following embodiment is merely an example, and the present information system is not limited to the configuration of the embodiment. In the following description of the embodiment, the Basic Input/Output System (BIOS) includes what is called Unified Extensible Firmware Interface (UEFI) in addition to the BIOS called Legacy BIOS of the related art.

### COMPARATIVE EXAMPLE

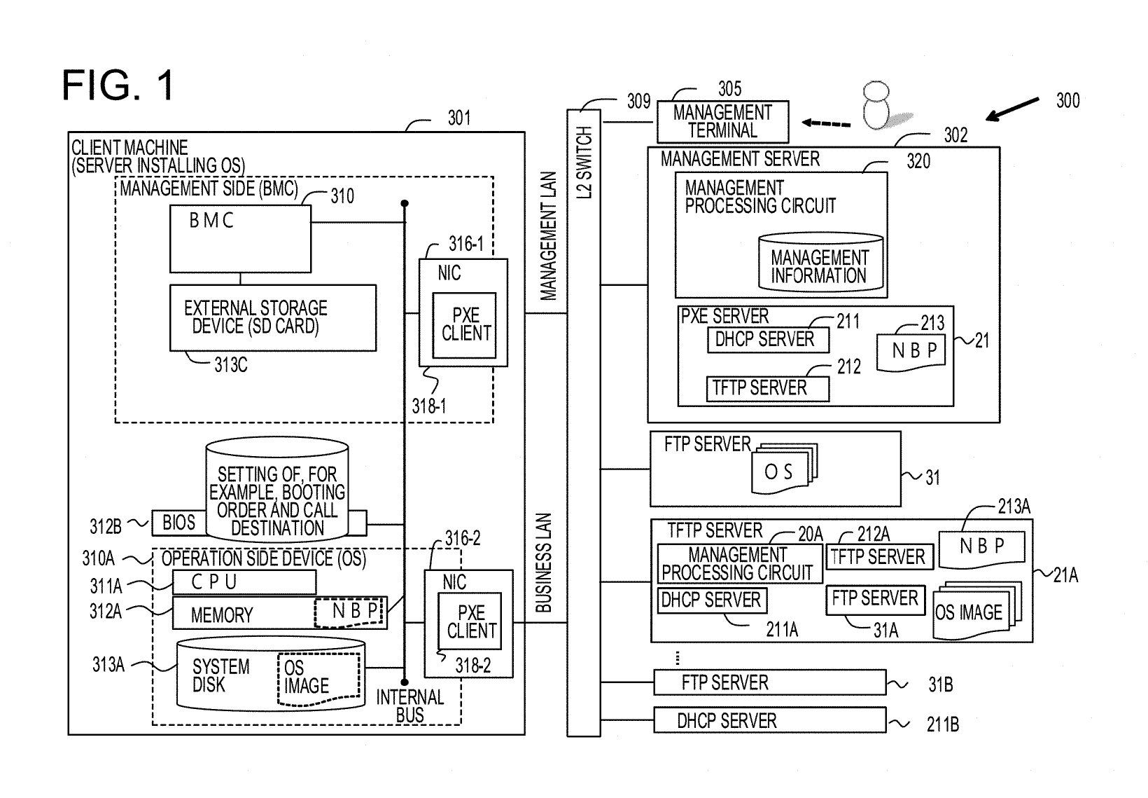

FIGS. 1 to 9 illustrate an information system 300 according to a comparative example. FIG. 1 is a view illustrating the configuration of the information system 300 according to the comparative example. The information system 300 of the comparative example includes a client machine 301, a management terminal 305, a management server 302, and a layer 2(L2) switch 309. The management server 302 includes a management processing circuit 320 and a PXE server 21. The management processing circuit 320 and the PXE server 21 may be an integrated server or a combination of plural separate computers. The PXE server 21 includes a DHCP server 211, a TFTP server 212, and a storage device for storing NBP 213. The PXE server 21 may be an integrated server or a system in which the separate DHCP server 211 and TFTP server 212, and a server including the storage device for storing the NBP 213 are linked with each other as the PXE server 21. The information system 300 of the comparative example further includes an FTP server 31 for providing, for example, an OS, a PXE server 21A, an FTP server 31B, and a DHCP server 211B. The PXE server 21A includes a management processing circuit 20A, a DHCP server 211A, and a TFTP server 212A. The PXE server 21A further includes an FTP server 31A, a storage device for storing NBP 213A, and a storage device for storing, for example, an OS image. For example, the PXE servers 21 and 21A include a management tool for collectively managing servers, storages, and networks in a cloud. However, the configuration of the information system 300 is not limited to that illustrated in FIG. 1. The information system 300 may have a configuration including, for example, PXE server/FTP server/DHCP server other than the configuration of FIG. 1.

The client machine 301 includes a base management controller (BMC) 310, an external storage device 313C, and an NIC 316-1 as management side devices. The client machine 301 further includes a read only memory (ROM) for storing a BIOS 312B, and an operation side device 310A.

The BMC 310 performs, for example, monitoring of, for example, the hardware (e.g., a CPU and a memory) and a temperature of the operation side device 310A, remote control, and recording of hardware events. The BMC 310 may be regarded as a processor which operates with a power source independent from the operation side device 310A and communicates with a system administrator by the independent communication means. The BMC 310 is included in a motherboard or a main board of a device to be monitored.

The BMC 310 is connected to the external storage device 313C to store various kinds of information. The NIC 316-1 is a communication means used by the BMC 310. A local area network (LAN) to which the NIC 316-1 is connected is called a management LAN. A PXE client 318-1 is installed in the NIC 316-1. The NIC 316-1 is used for a communication of the BMC 310, and is also used by the client machine 301 via the BMC 310 when the client machine 301 performs a communication by the IP address in a state where no IP address is allocated to an NIC 316-2 of a business LAN.

The BIOS 312B is a kind of firmware and a program for performing input/output of the lowest level with hardware which is peripheral devices of a computer and controlling the peripheral devices, among programs installed in the computer.

The operation side device 310A is, for example, a server that provides a user with a service by an application program. The operation side device 310A includes, for example, a CPU 311A, a memory 312A, and a system disk 313A. The operation side device 310A includes an NIC 316-2 which is a communication means independent from the communication means of the BMC 310. A LAN to which the NIC 316-2 is connected is called a business LAN. The NIC 316-2 further includes a PXE client 318-2. For example, the PXE client 318-2 is used for an update of the operation side device 310A.

The BMC 310, a ROM in which the BIOS 312B is stored, the operation side device 310A, the system disk 313A of the operation side apparatus 310A, and the NICs 316-1 and 316-2 are connected to each other by an internal BUS. When the client machine 301 is started, the BIOS checks a start mode (also referred to as a booting order) and starts the PXE client 318-1 when a start by PXE using the NIC 316-1 is prioritized. When the PXE client 318-1 is started, the PXE client 318-1 acquires an IP address from, for example, the DHCP server 211 on the segment of the network such as the L2 switch 309 and communicates with the network. Then, the PXE client 318-1 acquires, for example, the NBP 213 from, for example, the PXE server 21 and loads, for example, the acquired NBP 213 into the memory 312A. Then, the BIOS 312B executes an intended process, for example, installation of the OS or update of the firmware, by the NBP 213 loaded in the memory 312A. Hereinafter, the PXE clients 318-1 and 318-2 may be collectively simply referred to as a PXE client 318.

The L2 switch 309 forms a network segment for connecting among, for example, the client machine 301, the management terminal 305, the management server 302, the FTP server 31, the PXE server 21A, the FTP server 31B, and the DHCP server 211B.

The management terminal 305 supports the management of the information system 300 by the administrator. For example, the management terminal 305 transmits an instruction to the BMC 310 according to an operation of the administrator. That is, the management terminal 305 operates as an operation terminal that operates the management server 302.

The management server 302 manages the information system 300 including a device group connected to the network segment by, for example, the L2 switch 309. The management server 302 includes a management processing circuit 320 and the PXE server 21. As described above, the management processing circuit 320 and the PXE server 21 may be an integrated server or a combination of plural separate computers. The management processing circuit 320 includes a database for storing, for example, management information of each part of the information system 300 and a subnet address of the network.

Meanwhile, the PXE server 21 includes the DHCP server 211, the TFTP server 212, and the storage device of the NBP 213. The NBP 213 is a program which is delivered to the client machine 301 and started when the client machine 301 is PXE-booted. The DHCP server 211 receives a request from a computer (also referred to as a host) on the network segment formed by the L2 switch 309, dynamically allocates a network address (IP address), and transmits, for example, the allocated IP address, the subnet address, and the information of the NBP 213 to the host. In the comparative example, the DHCP server 211 provides the host with the information of the NBP 213 such as, for example, the IP address and the file name of the TFTP server 212 having the NBP 213. The TFTP server 212 provides the host with the NBP 213 in a simpler procedure than the FTP.

The FTP server 31 provides a file such as an OS image to the client machine 301 according to the FTP. As described above, the information system 300 further includes the PXE server 21A, the FTP server 31B, and the DHCP server 211B. The PXE server 21A includes the management processing circuit 20A, the DHCP server 211A, the TFTP server 212A, the FTP server 31A, the NBP 213A, and the OS image. For example, a user or an administrator of the information system 300 sometimes wishes to cause, for example, the plural PXE servers 21 and 21A to execute different processes, and there is a case where, for example, the PXE servers 21 and 21A are provided to execute the respective different processes.

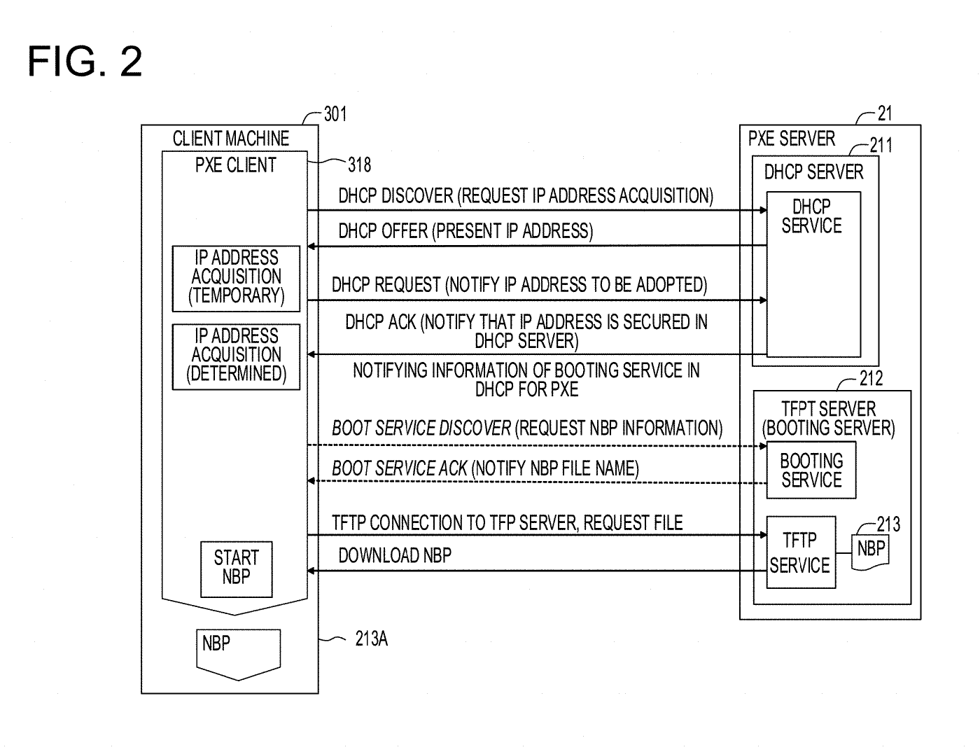

FIG. 2 is a view illustrating a procedure of PXE booting. In the PXE booting, a communication program called a PXE client for preparing to start a computer main body of, for example, the client machine 301 is installed on the computer main body. Then, at the time of starting the computer main body, the PXE client acquires and executes the NBP 213 from the PXE server 21 on the network. The PXE booting is a kind of the method of starting a computer.

In the PXE booting, for example, the PXE client 318 on the client machine 301 receives an allocation of an address on the network from the DHCP server 211 and acquires the information of the NBP 213.

That is, the PXE client 318 broadcasts an IP address acquisition request called DHCP Discover to a network segment. Then, the DHCP server 211 presents an IP address with a response called DHCP Offer. According to the DHCP Offer, the PXE client 318 temporarily acquires the IP address. Then, the PXE client 318 notifies the adopted IP address to the DHCP server 211 by broadcasting the IP address at a request called DHCP Request. Then, the DHCP server 211 notifies that the IP address has been secured by the DHCP server 211, with a response called DHCP Ack. According to the present comparative example, in the DHCP Ack, information of the NBP 213, which is information for executing a Boot service, is also transmitted.

However, the information of the NBP 213 may be provided in a procedure different from the DHCP Ack in some cases. For example, after the DHCP Ack is received, the PXE client 318 broadcasts a request called Boot Service Discover and requests the information of the NBP 213. Then, the DHCP server 211 may notify the IP address and the file name of the TFTP server having the NBP 213 with a response called Boot Service Ack (see a dotted line in FIG. 2).

When the information of the NBP 213 is acquired, the PXE client 318 accesses the TFTP server 212 to request a file. The TFTP server 212 transmits the NBP 213 in response to the request from the PXE client 318. The TFTP server 212 that executes such a process is also called a Boot server. When the NBP 213 is downloaded, the PXE client 318 starts the NBP 213 and executes a process according to the NBP 213.

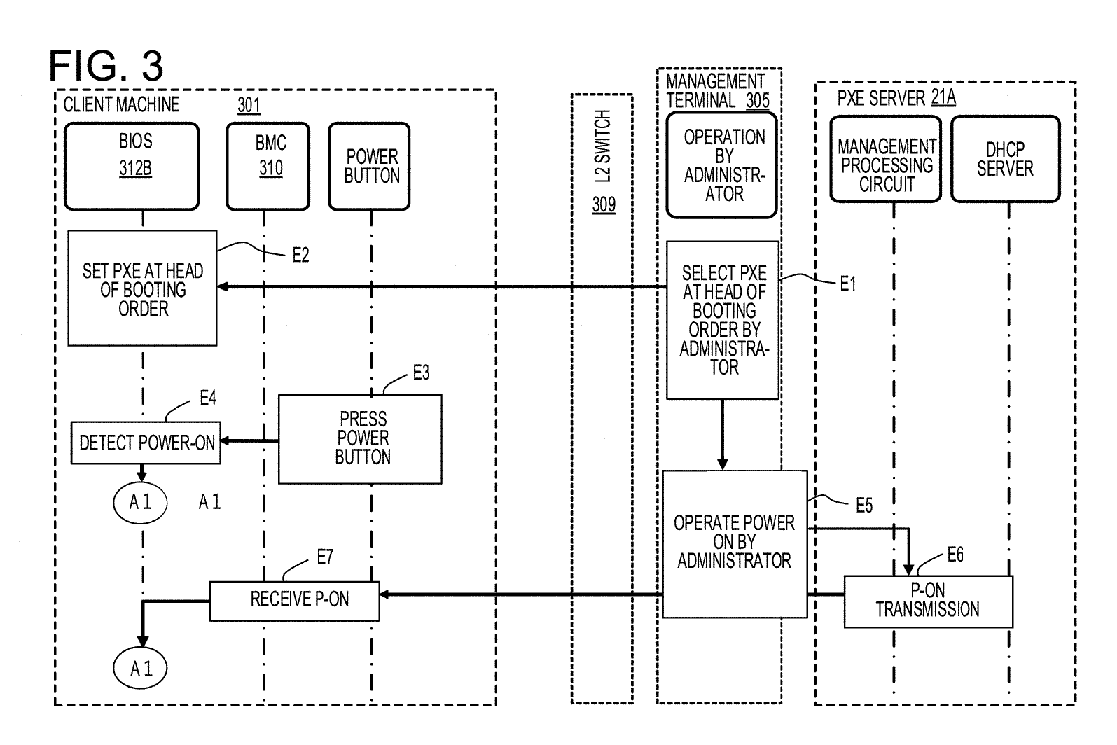

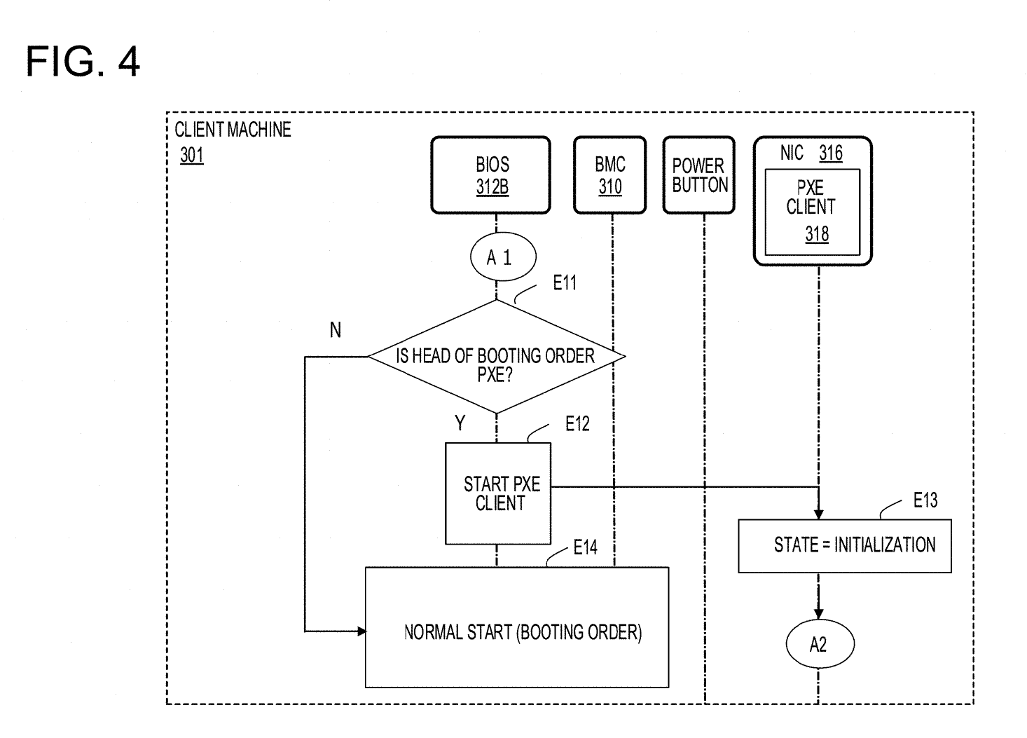

FIGS. 3 to 9 are sequence diagrams illustrating the PXE booting process of the comparative example. FIG. 3 illustrates PXE booting setting and power-on procedure by an administrator. First, the administrator selects and designates a PXE at the head of a booting order in the management terminal 305 (El). The booting order is the priority order of a booting device referred to by the BIOS 312 B at the time when the client machine 301 is started. When the PXE is designated at the head of the booting order, the BIOS 312B sets the PXE at the head of the booting order (E2). When a power button is pressed (E3), the BIOS 312B detects power-ON (E4). In the management terminal 305, the administrator may perform the operation of the transmission instruction of power-ON (E5) on, for example, the PXE server 21A. For example, according to the operation of the administrator in the management terminal 305, for example, the PXE server 21A transmits the power-ON (also referred to as P-ON) to the client machine 301 (E6). Then, the BMC 310 of the client machine 301 receives the P-ON from the PXE server 21A (E7). Upon receiving the P-ON via the NIC 316, the BMC 310 starts the BIOS 312B. Hereinafter, a process executed by the CPU 311A in accordance with the BIOS 312B will be described as a process executed by the BIOS 312B. In the present disclosure, when a processor executes a process according to a program, it may be described that the program executes the process. Thereafter, the sequence continues in FIG. 4 along a symbol A1.

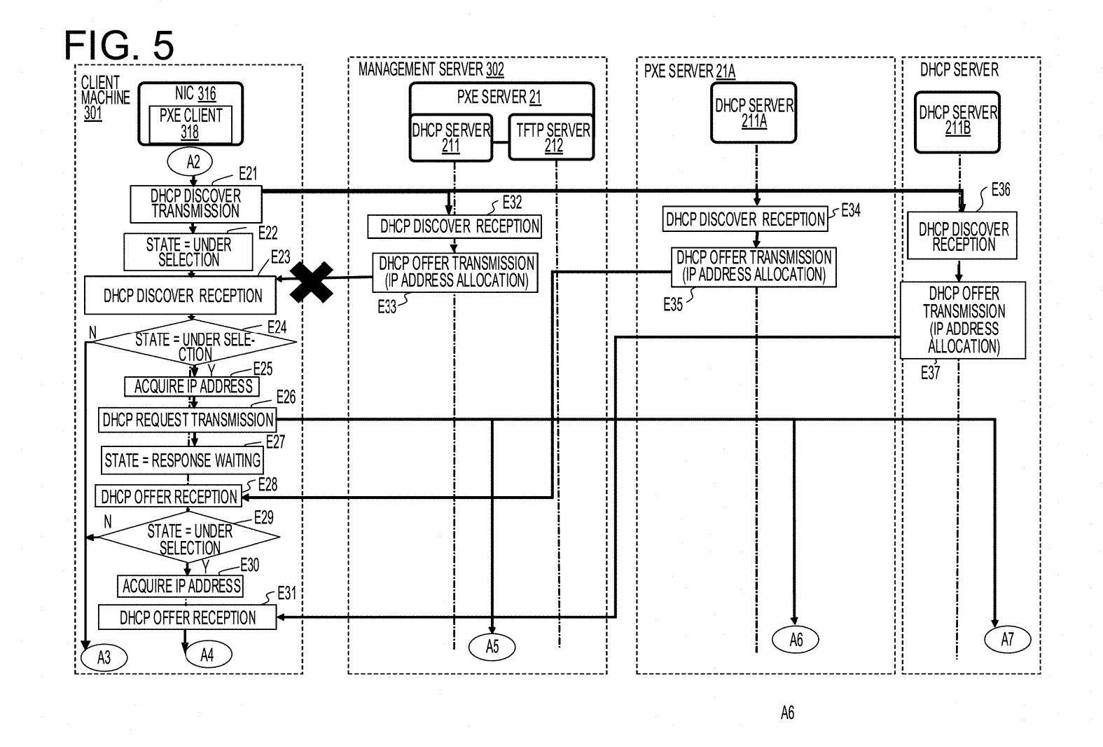

In FIG. 4, when the BIOS 312B is started, the BIOS 312B determines whether or not the head of the booting order is PXE (E11). When the head of the booting order is designated as the PXE, the BIOS 312B starts the PXE client 318 (E12). When the PXE client 318 is started by the BIOS 312B, the PXE client 318 sets a state of “initialization” in a register that manages a state (hereinafter referred to as a state register) (E13). Thereafter, the sequence continues in FIG. 5 along a symbol A2. Meanwhile, as a result of the determination in E11, when the head of the booting order is not designated as PXE, the BIOS 312B starts booting other than the PXE booting from the device designated in the normal booting sequence (E14).

As described above, the process in FIG. 5 continues from the symbol A2 in FIG. 4. When the client machine 301 is started by the PXE booting, the NIC 316 broadcasts the DHCP Discover (E21). Then, the NIC 316 sets a state of “under selection” in the state register (E22).

Upon receiving the DHCP Discover (E32, E34, and E36), the DHCP server 211 of the management server 302, the DHCP server 211A of the PXE server 21A, and the DHCP server 211B allocate respective IPs to the NIC 316 and transmit the DHCP Offer to the NIC 316 (E33, E35 and E37). It is now assumed that a server that executes a process intended by the administrator is originally the PXE server 21A, and not the PXE server 21. Then, in E33, the NBP information designated by the DHCP Offer transmitted from the DHCP server 211 of the PXE server 21 is information for designating an unintended NBP.

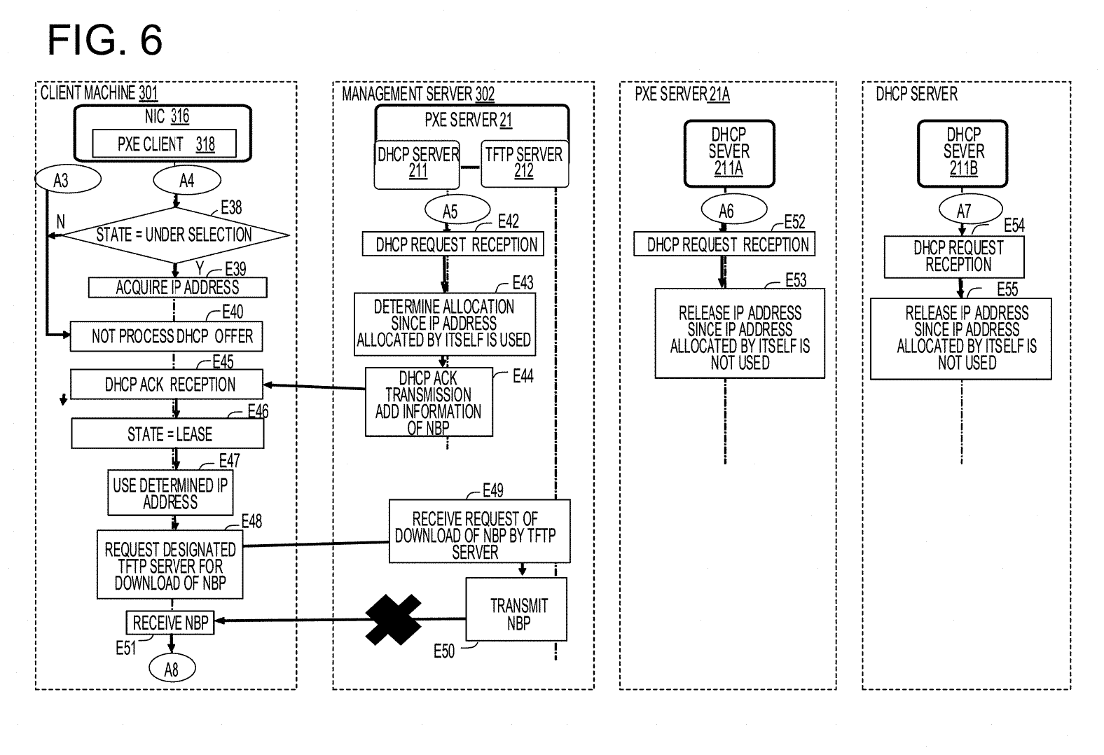

The NIC 316 receives the DHCP Offer including the allocated IP address (E23). Here, the received DHCP Offer includes NBP information designating an unintended TFTP server. Upon receiving the DHCP Offer, the NIC 316 determines whether or not the state register is in the state of “under selection” (E24). When it is determined that the state register is in the state of “under selection,” the NIC 316 acquires the IP address from the DHCP Offer (E25) and broadcasts the DHCP Request (E26). Then, the NIC 316 sets the state register to the state of “response waiting” (E27). The NIC 316 receives DHCP Offer from plural locations such as the DHCP servers 211A and 211B, and executes the same process (E28 to E30, E31, and E38 to E39). The process continues in FIG. 6 at the positions of symbols A3 to A7. Meanwhile, when it is determined that the state is not “under selection” in the determinations E24, E29 and E38, the NIC 316 does not process the DHCP Offer (E40).

In the example of FIG. 6, the IP address allocated by the DHCP server 211 of the PXE server 21 is used in the client machine 301. The DHCP server 211 receives the broadcast DHCP Request (E42) and determines the allocation (E43) since the IP address allocated by the DHCP server 211 is used. Therefore, the DHCP server 211 transmits DHCP Ack (E44). The DHCP server 211 adds the information of the NBP 213 to the DHCP Ack. Meanwhile, the DHCP server 211A and the DHCP server 211B of the PXE server 21A receive the broadcast DHCP Request (E52 and E54), and release the IP addresses allocated by the DHCP server 211A and the DHCP server 211B since the IP addresses are not used (E53 and E55).

Then, the NIC 316 of the client machine 301 receives the DHCP Ack from the DHCP 211 (E45). Then, the NIC 316 sets the state of “lease” in the state register (E46). Thereafter, the NIC 316 uses the determined IP address (E47). Then, the NIC 316 requests the TFTP server 212 designated in the DHCP Ack to download the NBP 213 (E48).

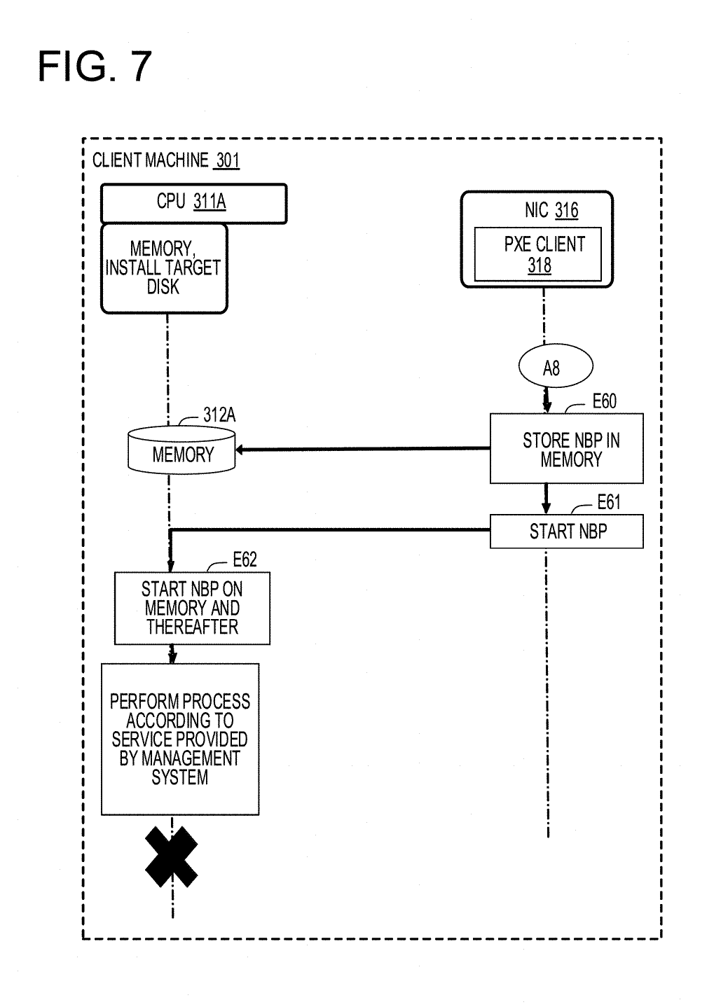

Then, the TFTP server 212 receives the request for downloading the NBP 213 (E49). Then, the TFTP server 212 transmits the NBP 213 to the NIC 316 (E50). The NIC 316 receives the NBP 213 (E51), and thereafter, the process of FIG. 6 continues in FIG. 7 along a symbol A8. The NBP 213 received in E51 is an unintended NBP.

In FIG. 7, the NIC 316 stores the NBP 213 received from the TFTP server 212 in the memory 312A (E60). Then, the NIC 316 instructs the CPU 311A to start the NBP 213 on the memory 312A (E61). However, since the client machine 301 has acquired the unintended NBP information and NBP (E23 and E51), the CPU 311A starts the unintended NBP (E62). Then, a process of the NBP 213 that happens to be downloaded is executed.

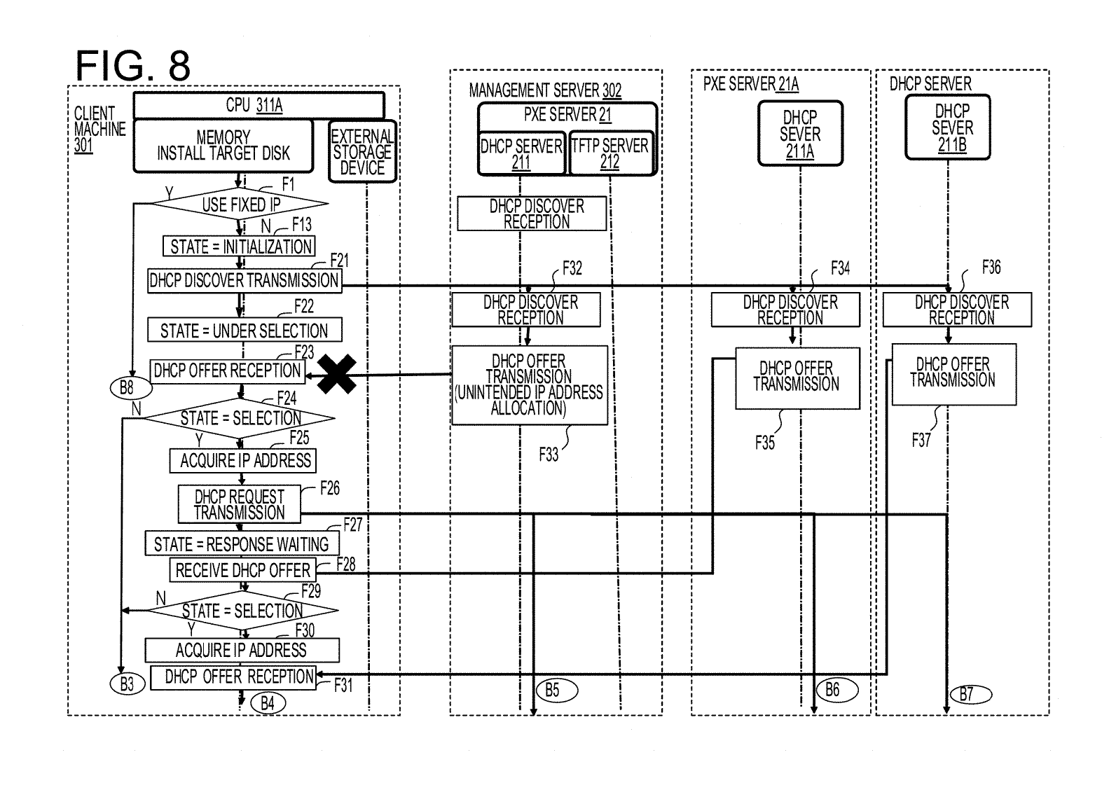

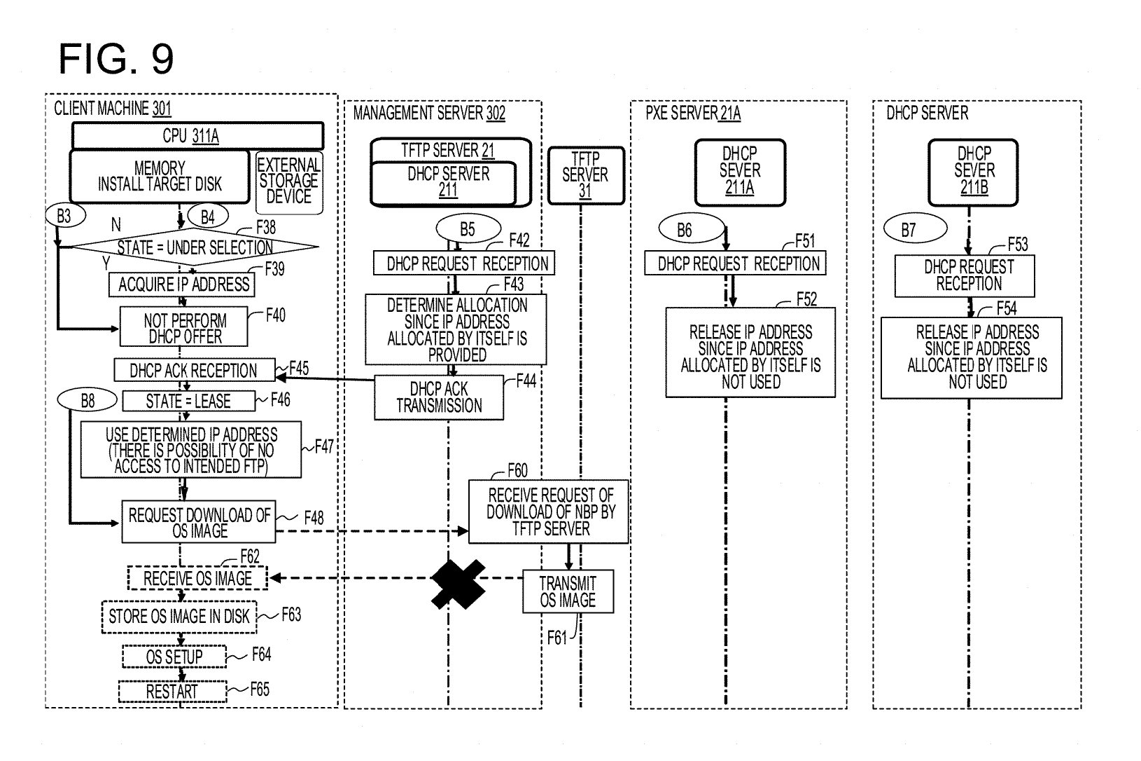

FIGS. 8 and 9 illustrate problems occurring in subsequent procedures even though the intended NBP information is notified by the DHCP server 211A of the intended PXE server 21A in the process of FIGS. 3 to 7. That is, it is here assumed that addresses are allocated by the DHCP server 211A of the intended PXE server 21A in the same procedure as FIGS. 3 to 7. Then, similarly to FIG. 7, the CPU 311A of the client machine 301 starts the NBP 213A stored in the memory 312A. FIG. 8 illustrates a process after the CPU 311A of the client machine 301 starts the NBP 213A stored in the memory 312A. In this process, the CPU 311A of the client machine 301 determines whether or not to use a fixed IP address (F1). When it is determined to use a fixed IP address, the process of the CPU 311A continues to a process after a symbol B8 in FIG. 9 continuing from the symbol B8 in FIG. 8.

Meanwhile, when it is determined not to use the fixed IP address, the process of the CPU 311A sets the state register to “initialization” and broadcasts the DHCP Discover to the network segment (F21). The process from F21 in FIGS. 8 to F46 in FIG. 9 is the same as the process from E21 in FIGS. 5 to E46 in FIG. 6, except that the CPU 311A broadcasts the DHCP Discover. In this case as well, in F33, there is a possibility that the CPU 311A receives the DHCP Offer including the IP address allocated by the unintended DHCP server 211 for the first time in F23. In that case, in F47, the IP address to be determined may be an address that cannot access an intended TFTP server (or FTP server). For example, in the example of FIG. 1, the systems of IP addresses allocated by the DHCP server 211 and the DHCP server 211A may be different from each other. As a result, even when the CPU 311A transmits a download request of the OS image to the intended FTP server (F48), there is a possibility that the CPU 311A cannot access the intended FTP server. This is because the address systems allocated by the intended DHCP server 211A and the actually allocating DHCP server 211 may be different from each other (F60 and F61).

When the IP address allocated by the intended DHCP server 211A and the fixed IP address are used, the CPU 311A transmits an OS image download request to the intended FTP server (F48), and the original intended OS image is transmitted (F61). In this case, the CPU 311A receives the OS image (F62), stores the OS image in an external storage device such as a disk (F63), sets up the OS (F64), and restarts the client machine 301 (F65). In this way, the update may be executed normally.

### PROBLEMS OF COMPARATIVE EXAMPLE

As described above, in the information system 300 of the comparative example, there may be problems when each program receives a response from the DHCP server.

(Problem with PXE Client)

In an environment where, for example, plural PXE servers 21 are arranged in the same network segment, for example, plural DHCP servers 211 respond to a DHCP request message (DHCP Discover) broadcast by the PXE client 318, and the PXE client 318 adopts a response (DHCP Offer) received for the first time. For this reason, a DHCP server from which the PXE client 318 is to adopt a response may not be determined. The adopted response of a DHCP server may be merely an IP allocation or may have additional NBP information of a service provided by an unintended PXE server. Therefore, the PXE client 318 cannot download the intended NBP, for example, the NBP 213A in FIG. 1, and cannot perform an expected process in the client machine 301 (see FIGS. 3 to 7).

(Problem after Download of Intended NBP)

Even though the PXE client 318 could download the intended NBP 213A, the same problem occurs when the NBP acquires an IP address. That is, when the PXE client 318 acquires an IP address from an unintended DHCP server, the PXE client 318 may not be able to access the FTP server because the address system of the IP address is different from that of the intended FTP server (see FIGS. 8 and 9).

From the above, when plural PXE servers and DHCP servers are arranged in the same network segment, it may be conceivable to temporarily stop servers other than an intended server. However, every time PXE booting is performed for each client machine, other services are stopped, which affects the system operation. In the following embodiments, in a network system in which PXE booting is performed, it is possible to arrange products having functions of plural PXE servers on the same network segment and to operate the PXE servers without temporarily stopping the PXE servers.

### First Embodiment

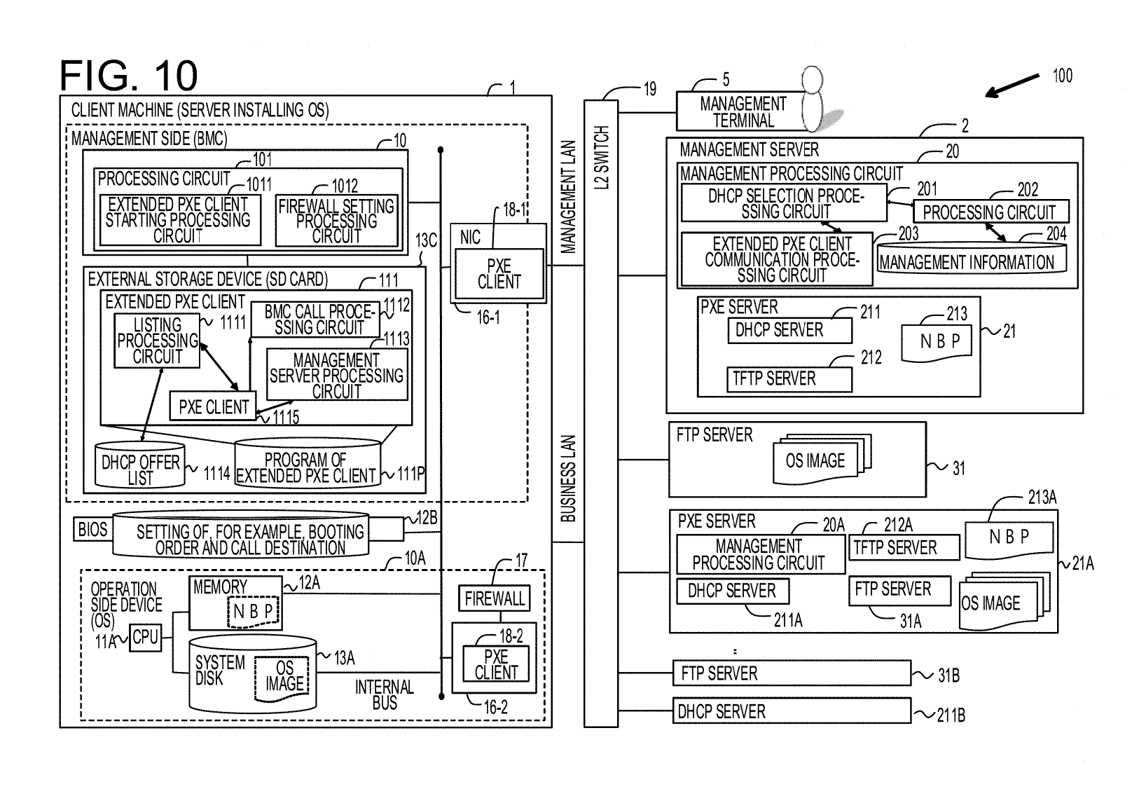

Hereinafter, an information system 100 according to a first embodiment will be described with reference to FIGS. 10 to 27. The information system 100 has a system configuration in which products having functions of plural PXE servers are arranged in the same network segment. The information system 100 makes an improvement to loosen the operation restrictions or make the operation restrictions unnecessary as much as possible such as temporarily stopping unintended PXE servers.

<Structure>

FIG. 10 is a view illustrating the configuration of the information system 100 according to the first embodiment. The information system 100 includes, for example, a client machine 1, a management terminal 5, a management server 2, and an L2 switch 9.

In the information system 100, the client machine 1 executes a program of a PXE client (hereinafter referred to as an extended PXE client 111) in order to make the above-described improvement. In the information system 100, in order to make the above-described improvement, the management server 2 includes a management processing circuit 20. The management processing circuit 20 includes a DHCP selection processing circuit 201 that selects a DHCP server, a processing circuit 202 that executes retrieval, etc. of management information 204, and an extended PXE client communication processing circuit 203 that communicates with the extended PXE client 111.

The client machine 1 includes a BMC 10, an external storage device 13C (e.g., an SD card), and an NIC 16-1 as a management side device configuration. The client machine 1 further includes a ROM that stores a BIOS 12B, and an operation side apparatus 10A.

The BMC10 includes a processor such as a CPU, and a memory, and is hardware capable of being always operated at the time of current conduction of the client machine 1. In the BMC 10, the processing circuit 101 has a function of an extended PXE client starting processing circuit 1011 for starting the extended PXE client 111 and a function of a firewall setting processing circuit 1012.

When the client machine 1 is started, the extended PXE client starting processing circuit 1011 determines whether a booting order designates PXE booting or normal start. When it is determined that the PXE booting is designated, the extended PXE client starting processing circuit 1011 starts the extended PXE client 111.

The firewall setting processing circuit 1012 sets a communication restriction in a firewall 17 and limits the transmission destination of a DHCP message. More specifically, the firewall setting processing circuit 1012 receives information such as an IP address and a subnet address allocated to the NIC 16 used by the extended PXE client 111 from, for example, the DHCP server 211 or the like selected by the communication between the extended PXE client 111 and the management server 2. Then, the firewall setting processing circuit 1012 sets the firewall 17 so as not to perform a communication with networks other than the network designated by the subnet address, and restricts the communication.

The external storage device 13C is installed exclusively for the BMC 10 and may be used by the BMC 10. The external storage device 13C holds a program file 111P in an executable form of the extended PXE client 111, and a DHCP Offer list 1114 for temporarily holding responses from plural DHCP servers. An area of the program file 111P in the executable form of the extended PXE client 111 is converted into a virtual disk by the BMC 10. The program file 111P stored in the virtualized area is booted by the BIOS 12B and placed in the memory 12A. However, FIG. 10 illustrates a state in which the extended PXE client 111 is deployed on the external storage device 13C.

The extended PXE client 111 is a functional extension of the PXE client 18 for the purpose of being able to use an intended DHCP server among, for example, plural DHCP servers 211. The extended PXE client 111 includes a DHCP Offer listing processing circuit 1111, a BMC call processing circuit 1112, a management server processing circuit 1113, and a PXE client 1115.

The DHCP Offer listing processing circuit 1111 lists the DHCP Offer received by the client machine 1. The BMC call processing circuit 1112 is an interface that calls the BMC 10, for example, when a process in the extended PXE client 111 is ended. The management server processing circuit 1113 performs a process of a communication between the extended PXE client 111 and the management server or the firewall. The PXE client 1115 transmits the DHCP Discover, receives the DHCP Offer from the plural DHCP servers, and delivers the information included in the DHCP Offer to the DHCP Offer listing processing circuit 1111.

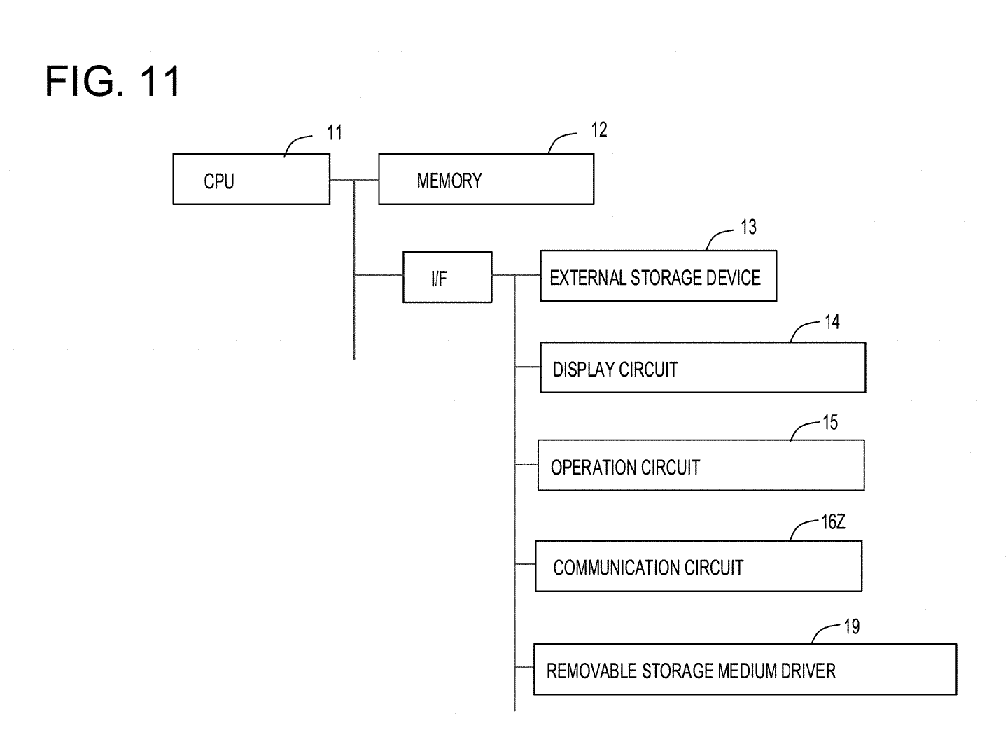

The client machine 1 has, for example, the firewall 17 as a function for limiting the transmission destination of the DHCP message. The firewall 17 may be exemplified as a relay device that relays between the client machine 1 and a network segment connected via the L2 switch. The firewall 17 includes, for example, a CPU 11, a memory 12, and a communication circuit 16Z illustrated in FIG. 11. However, at least part of a process to be executed by the CPU 11 and the memory 12 may be implemented by a hardware circuit. The firewall 17 permits a communication between the client machine 1 and a network having a specific subnet address, and blocks a communication with a network having another specific subnet address. The firewall 17 is an example of a communication control circuit.

The management server 2 includes the PXE server 21 and includes the management processing circuit 20 as described above. The management processing circuit 20 includes the DHCP selection processing circuit 201 that selects, for example, the DHCP server 211 to be used by the client machine 1, the processing circuit 202 that executes, for example, retrieval of the management information 204, and the extended PXE client communication processing circuit 203 that communicates with the extended PXE client 111. The management server 2 is an example of a support apparatus. As illustrated in FIG. 10, in the first embodiment, the management server 2 as the support apparatus is connected to the client machine 1 as the information processing apparatus via a network exemplified by the L2 switch 9.

The management processing circuit 20 and the PXE server 21 may be an integrated server or a combination of plural separate computers. When the management processing circuit 20 and the PXE server 21 are mounted on an integrated computer, the management processing circuit 20 and the PXE server 21 may be regarded as one of services or processes provided by a program on the computer. Hereinafter, the integrated computer refers to, for example, computer hardware accommodated in a housing.

Further, since, for example, the PXE servers 21 and 21A have the same configuration as those in the above-described comparative example, explanation thereof will be omitted. The management processing circuit 20A of the PXE server 21A may be the same as that in the comparative example, or may include, for example, the DHCP selection processing circuit 201 similarly to the management processing circuit 20. Further, as described above, the PXE server 21 itself may be an integrated computer, or a system in which separate DHCP server 211 and TFTP server 212 and a server including a storage device for storing the NBP 213 are linked with each other as the PXE server 21. When the PXE server 21 is an integrated computer, the DHCP server 211, the TFTP server 212, and the server including the storage device for storing the NBP 213 may be regarded as a service or process provided by the program on the computer.

Similarly to the information system 300 of the comparative example, the information system 100 further includes the FTP server 31, the PXE server 21A, the FTP server 31B, and the DHCP server 211B. Similarly to the comparative example, the PXE server 21A includes the DHCP server 211A, the TFTP server 212A, the FTP server 21A, the NBP 213A, and the storage device that stores, for example, the OS image. Since the configurations of, for example, the FTB servers 31 and 31B, the PXE server 21A, the DHCP server 211B, and the PXE server 21 in the management server 2 are the same as those of the comparative example (FIG. 1), explanation thereof will be omitted. The PXE server 21 and the PXE server 21A are examples of plural server devices. The DHCP server 211 and the DHCP server 211A are examples of an allocation circuit for allocating an address on the network. The TFTP server 212 is an example of a providing circuit that provides a program to be started by an information processing apparatus to the information processing apparatus to which an address is allocated. However, the configuration of the information system 100 is not limited to that illustrated in FIG. 10. The information system 100 may have a configuration further including, for example, a PXE server/FTP server/DHCP server in addition to the configuration of FIG. 10.

<Hardware Configuration>

FIG. 11 is a view illustrating a hardware configuration of a computer included in the information system according to the first embodiment, for example, the client machine 1, the BMC 10, the firewall 17, the management server 2, and the management terminal 5 (hereinafter simply referred to as an information processing apparatus). The information processing apparatus includes the CPU 11, the memory 12, and external devices connected via an interface (I/F), and executes information processing by a program. The CPU 11 is also referred to as a processor. The memory 12 is also referred to as a main memory. Examples of the external devices may include an external storage device 13, a display 14, an operation circuit 15, a communication circuit 16Z, and a removable storage medium drive circuit 19.

The CPU 11 executes a computer program deployed on the memory 12 to provide the functions of the information processing apparatus. The memory 12 stores, for example, the computer program (including what is called firmware) to be executed by the CPU 11, and data to be processed by the CPU 11. The memory 12 is, for example, a dynamic random access memory (DRAM), a static random access memory (SRAM), or a read only memory (ROM). The external storage device 13 is used as, for example, a storage area for supplementing the memory 12 and stores, for example, the computer program to be executed by the CPU 11 and data to be processed by the CPU 11. The external storage device 13 is, for example, a hard disk drive or a solid state disk (SSD).

The display 14 is, for example, a liquid crystal display or an electroluminescence panel. The operation circuit 15 is, for example, a keyboard or a pointing device. In the first embodiment, a mouse is exemplified as the pointing device. The communication circuit 16Z exchanges data with other devices on the network. The removable storage medium drive circuit 19 is, for example, an input/output device for a Blu ray disc, a digital versatile disk (DVD), a compact disc (CD), or a flash memory card.

The BMC 10 and the firewall 17 may include the CPU 11, the memory 12, and the communication circuit 16Z connected via the interface (I/F). Therefore, for example, the external storage device 13 and the display 14 may not be provided for the BMC 10 and the firewall 17.

<Example of Data Configuration and Screen>

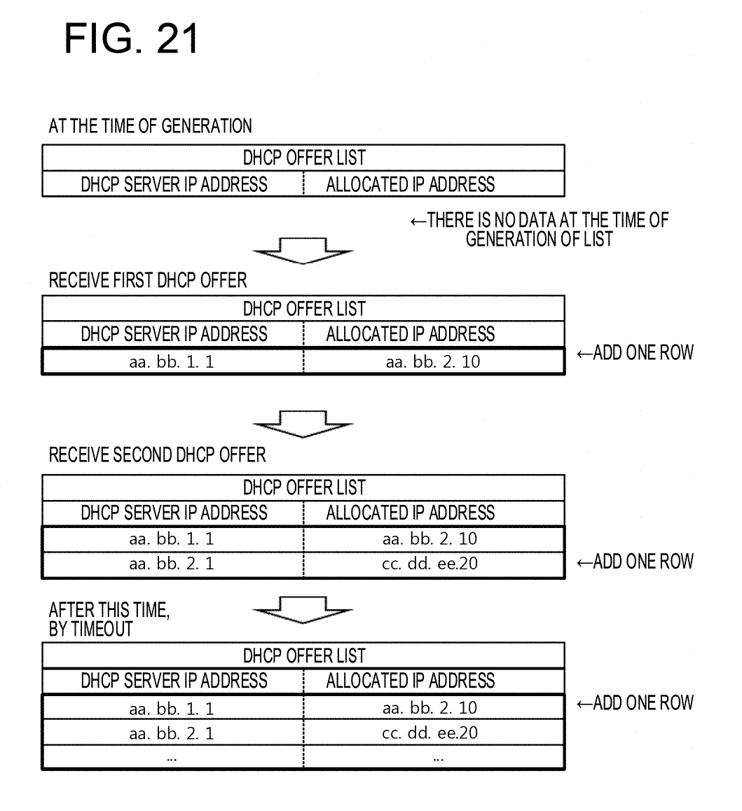

Hereinafter, the configuration of data exchanged or accumulated among the elements of the information system 100 and the configuration of a screen will be illustrated with reference to FIGS. 21 to 27.

FIG. 21 illustrates the configuration of a DHCP Offer list. The DHCP Offer list is a list for the extended PXE client 111 of the client machine 1 to manage the IP address allocation response (DHCP Offer) received from, for example, the plural DHCP servers 211. As illustrated in FIG. 21, the DHCP Offer list has a pair of information, that is, an IP address of a DHCP server as the transmission source of DHCP Offer: an allocated IP address. The DHCP Offer list is empty in the initial state immediately after the extended PXE client 111 is started. When the started extended PXE client 111 transmits the DHCP Discover, for example, the plural DHCP servers 211 respond to the DHCP Discover. Therefore, every time the DHCP Offer is received by the extended PXE client 111, the pair of information is added to the DHCP Offer list. The DHCP Offer list is an example of a response list including plural pairs of allocated addresses and identification information for identifying allocation circuits that allocated the addresses. The IP address of the DHCP server is an example of the identification information for identifying the allocation circuits.

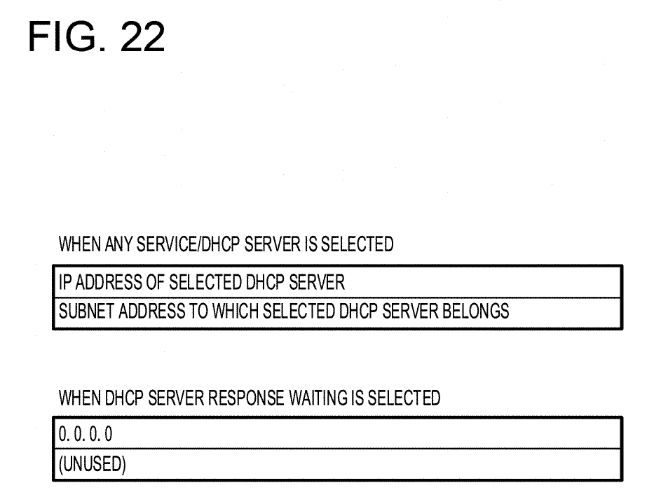

FIG. 22 illustrates the configuration of DHCP server selection response information received from the management server 2 when the extended PXE client 111 transmits a DHCP Offer list to the management server 2. The DHCP server selection response information includes an IP address of, for example, the DHCP server 211 selected by the management server 2 and a subnet address to which, for example, the selected DHCP server 211 belongs. However, the actual value of the DHCP server selection response information differs depending on whether or not the DHCP server is selected in the management server 2. That is, when, for example, any one service/DHCP server 211 is selected in the management server 2, the DHCP server selection response information has the value as configured above. The DHCP server selection response information is an example of specific information for specifying an allocation circuit of a server device. The subnet address to which, for example, the selected DHCP server 211 belongs is an example of network identification information for identifying a network by which an address allocated by the allocation circuit of the selected server device is used.

Meanwhile, when even the service/DHCP server 211 is not selected in the management server 2, 0.0.0.0 is set in the DHCP server selection response information. The information “0.0.0.0” is information that the management server 2 instructs the extended PXE client 111 to wait for a selection response.

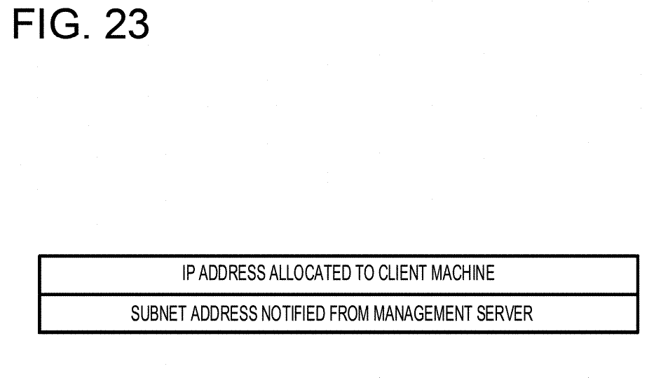

FIG. 23 illustrates the configuration of firewall setting information notified from the extended PXE client 111 to the firewall setting processing circuit 1012 of the BMC 10. The firewall setting information has an IP address allocated to the client machine 1 and a subnet address notified from the management server 2.

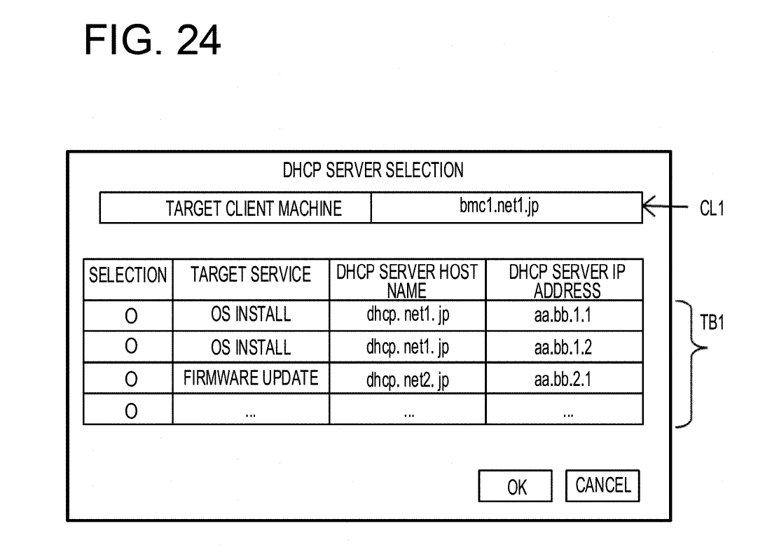

FIG. 24 illustrates the configuration of information displayed on a DHCP server selection screen (pre-selection). The DHCP server selection screen (pre-selection) is a screen that supports the selection of a DHCP server by the administrator in the management server 2. The DHCP server selection screen (pre-selection) includes a target client machine input field CL1, a display area of a DHCP list TB1, an OK button, and a CANCEL button. The target client machine input field CL1 is an input field for designating a target client machine 1 to which a selected service is applied. A host name of the BMC 10 of the target client machine 1 or an IP address of the NIC 16-1 connected to the BMC 10 is designated in the target client machine input field CL1.

The DHCP list TB1 displays a list of DHCP servers to be selected, and receives a selection of a service, that is, for example, the DHCP server 211 from the administrator. Therefore, the DHCP list TB1 has a tabular form, and each row of the table has fields of a selection field, a target service field, a host name field of the DHCP server, and an IP address field of the DHCP server. Each row of the table corresponds to one DHCP server. One service may be composed of plural DHCP servers. The DHCP list TB1 may be regarded as a list of DHCP servers managed by the management server 2.

Among the fields of the table, the selection field is a field for inputting a selection designation when the administrator selects the target service. The target service field is information indicating a process or a function to be executed by the service or the NBP 213 provided by, for example, the PXE server 21. The host name field of the DHCP server is a field indicating the host name of, for example, the DHCP server 211 grasped by the management server 2. The IP address field of the DHCP server is a field indicating the IP address of, for example, the DHCP server 211 in the relevant row.

When the OK button is operated on the DHCP server selection screen (pre-selection), the information set in the DHCP server selection screen (pre-selection) is saved as DHCP selection information in the management server 2. The DHCP selection information is, for example, a part of the management information 204 in FIG. 10. The data format of the saved DHCP selection information is the same as the arrangement of data on the screen of FIG. 24. That is, the saved DHCP selection information includes, for example, the host name and IP address of the BMC 10 of the target client machine to which the DHCP selection information is applied, the target service provided by the PXE server, and the host name and IP address of the DHCP server that belongs to the PXE server. The DHCP selection information is an example of selection information for selecting any allocation circuit of plural server devices. Since the DHCP selection information is an example of the selection information, in the first embodiment, the management server 2 has the selection information and may be an example of a management device connected via a network. When the CANCEL button is operated, the information set in the DHCP server selection screen (pre-selection) is discarded.

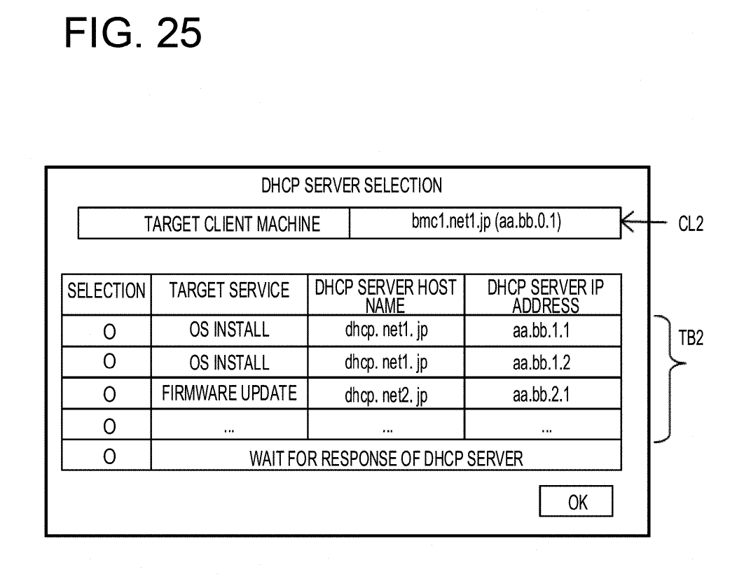

FIG. 25 illustrates the configuration of information displayed in a DHCP server selection screen (post-selection). When a DHCP server selection is not designated in advance on the DHCP server selection screen (pre-selection), the DHCP server selection screen (post-selection) is a screen that supports the DHCP server selection by the administrator from the DHCP Offer list received by the management server 2. The configuration of the DHCP server selection screen (post-selection) is substantially the same as that of the DHCP server selection screen (pre-selection) illustrated in FIG. 24. The DHCP server selection screen (post-selection) includes a target client machine display field CL2, a display area of a DHCP list TB2, and an OK button.

Among them, the target client machine display field CL2 displays the host name (host name FQDN) and IP address of the BMC 10 of the target client machine 1 so as to distinguish the target client machine 1 when a process is executed by plural client machines 1. The IP address of the BMC 10 may be detected as a transmission source IP address when the DHCP Offer list is received. That is, a communication that is not broadcast between the client machine 1 and the management server 2 is performed via the BMC 10 until the allocation of the IP address to the client machine 1 is determined after the target DHCP server is determined. For example, a communication from the client machine 1 to the management server 2 is performed via the BMC 10.

The DHCP list TB2 is a list of DHCP servers included in the DHCP Offer list notified from the client machine 1. When there is no DHCP that the administrator wishes to select in the DHCP server list notified from the client machine 1, it means that the DHCP Offer has not yet reached the client machine 1 from an intended DHCP server. In this case, since the intended service/DHCP server is not displayed, the management server 2 instructs the client machine 1 to extend the DHCP server response (DHCP Offer) waiting according to an input from the administrator. Therefore, the DHCP list TB2 has an option “wait for DHCP server response.” The option of “waiting for DHCP server response” is an option for designating an extension for response waiting.

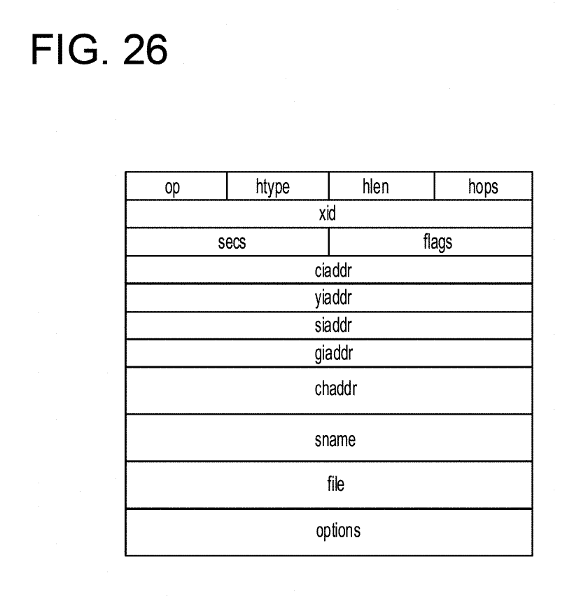

FIG. 26 illustrates the configuration of a DHCP message. Elements of the DHCP message are as follows. The “op” is data of one byte and designates an operation code. When the value of op is 1, it means BOOTREQUEST, and the DHCP message is transmitted from the client machine 1 to, for example, the DHCP server 211. When the value of op is 2, it means BOOTREPLY, and the DHCP message is transmitted from, for example, the DHCP server 211 to the client machine 1.

The “htype” is data of one byte and designates a hardware number. The “hlen” is data of one byte and designates a hardware address length. The “hops” is data of one byte and designates a transfer count. The “xid” is data of 4 bytes and designates a transaction ID. Details of the hardware number, the hardware address length, the transfer count, and the transaction ID are omitted.

The “secs” is data of 2 bytes and a lapse time is set therein. The lapse time is the number of seconds since a client started initialization.

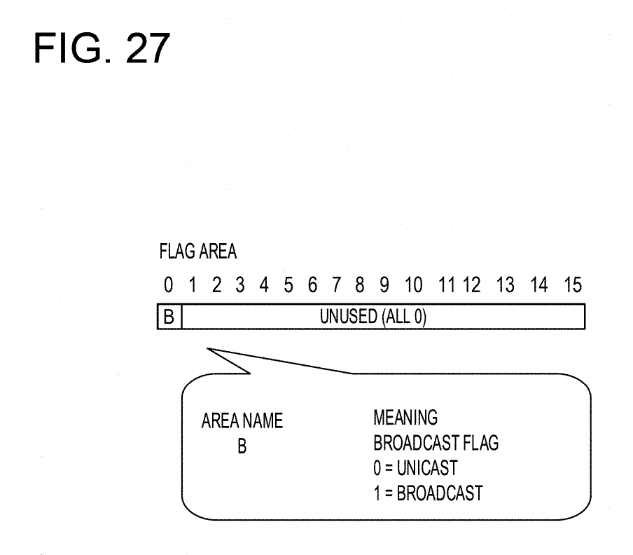

The “flags” is data of 2 bytes and a flag (see FIG. 27) is set therein.

The “ciaddr” is data of 4 bytes and a client IP address is set therein. The client IP address is an IP address already allocated to the client machine 1.

The “yiaddr” is data of 4 bytes and is an allocated IP address. The allocated IP address is an IP address allocated to the client machine 1 by, for example, the DHCP server 211.

The “siaddr” is data of 4 bytes and is an IP address of, for example, the DHCP server 211. The IP address of, for example, the DHCP server 211 is an IP address of, for example, the DHCP server 211 notified by, for example, the DHCP server 211 with DHCP Offer or DHCP Ack.

The “giaddr” is data of 4 bytes and is a relay agent IP address. Details of the relay agent are omitted.

The “chaddr” is data of 16 bytes and is a client hardware address (MAC address).

The “sname” is data of 64 bytes and is a server name.

The “file” is data of 128 bytes and is a booting file name.

The “options” is variable length data and options are designated therein. Details of options are omitted.

FIG. 27 is a view illustrating the detailed configuration of flags in FIG. 26. The flags is a 16-bit flag area, and the first bit (0-th bit) is a broadcast flag B. When B is 0, it means that a DHCP message is unicast. When B is 1, it means that the DHCP message is broadcast. Bits 1 through 15 of flags are unused.

<Specific Processing Example of Each Element>

As described above, in the information system 100, the extended PXE client 111 of the client machine 1 temporarily receives the IP address allocation response (DHCP Offer) from, for example, the plural DHCP servers 211. Then, the client machine 1 generates the DHCP Offer list 1114 as a list of IP address allocation responses (FIG. 21). The management server 2 receives, from the administrator who grasps the PXE booting that matches the purpose of a processing that is desired to be executed from now, a designation that associates the target client machine 1 with the DHCP server for using the target service in advance. The information associating the client machine 1 with the DHCP server for using the target service will be hereinafter referred to as DHCP selection information. Further, the DHCP server for using the target service will simply be referred to as a “target DHCP server.” The management server 2 receives a designation of DHCP selection information by the DHCP server selection screen (pre-selection) illustrated in FIG. 24.

In the first embodiment, the management server 2 receives the DHCP Offer list 1114 from the extended PXE client 111. Then, based on the DHCP selection information, the management server 2 selects one target DHCP server from among DHCP servers registered in the DHCP Offer list 1114. The management server 2 returns information related to the selected target DHCP server to the client machine 1. According to the selection by the management server 2, the client machine 1 is able to automatically specify and communicate with a server (such as a DHCP server/TFTP server) that provides the target service. As a result, even in a case where the PXE booting is used in an environment where, for example, plural PXE servers 21 exist in the same network segment, the information system 100 exemplifies one improvement plan to the problems presented in the comparative example and makes the target service available.

When the administrator does not designate the target client machine 1 and the DHCP server 211 of the PXE booting in advance, a posterior selection may be made by the DHCP server selection screen (post-selection) illustrated in FIG. 25. For example, the management server 2 may prompt the administrator to select a target DHCP server based on the DHCP Offer list 1114 generated by the client machine 1.

(1) Process of Extended PXE Client 111

The extended PXE client 111 temporarily holds a DHCP Offer which is a response from the plural DHCP servers to the broadcast DHCP Discover. Then, the extended PXE client 111 uses the received DHCP Offer to request the management server 2 to select a DHCP server. Then, based on the DHCP selection information set by the system administrator, the management server 2 selects a target DHCP server corresponding to a service provided by the PXE server. With such a configuration and operation, in the information system 100, the client machine 1 using the PXE booting is able to communicate with the desired PXE server. The client machine 1 may be an example of an information processing apparatus.

(1.1) The extended PXE client 111 receives and lists plural DHCP Offers to generate a DHCP Offer list 1114, deliver the generated DHCP Offer list 1114 to the management server 2, and receives a selection of an item in the DHCP Offer list 1114 by the management server 2. That is, the extended PXE client 111 transmits the DHCP Offer list 1114 to the management server 2 and receives, from the management server 2, the IP address of the DHCP server 211 used by the extended PXE client 111 and the subnet information to which the IP address belongs. As a result, one of the plural DHCP servers 211 registered in the DHCP Offer list 1114 is selected, and it is determined that the extended PXE client 111 uses the IP address allocated by the selected DHCP server 211.

(1.2) When there is a response from, for example, the DHCP server 211, the extended PXE client 111 generates an empty DHCP Offer list 1114 when being started. The extended PXE client 111 is an example of a processing circuit of the information processing apparatus.

In addition, the extended PXE client 111 starts a DHCP Offer waiting timer while transmitting the DHCP Discover. The DHCP Offer waiting timer is provided to wait for an unspecified and unknown DHCP server response. The waiting time is, for example, 4 seconds which are equal to a recommended value (first retry) in DHCP. The pair of information continues to be added to the DHCP Offer list 1114 until the DHCP Offer waiting timer times out.

When the DHCP Offer waiting timer ends, the extended PXE client 111 transmits the DHCP Offer list 1114 to the management server 2. Since DHCP server selection is performed in the management server 2, the extended PXE client 111 receives the DHCP server selection response information (FIG. 22) including the IP address and subnet address of the selected DHCP server as a response.

The extended PXE client 111 specifies, for example, the DHCP server 211 selected by the management server 2 according to the DHCP server selection response information. Then, the extended PXE client 111 extracts the IP address allocated from, for example, the selected DHCP server 211, from the DHCP Offer list 1114. Then, the extended PXE client 111 sets the IP address allocated from the selected DHCP server 211 in the DHCP Request and broadcasts the DHCP Request to the selected DHCP server 211. Then, DHCP Ack is transmitted from the intended (or target) DHCP server as the transmission destination, and the unintended DHCP servers releases the secured IP addresses.

(1.3) When there is no response from an intended DHCP server and when there is a response from an unintended DHCP server, the following process is executed. That is, as described in FIG. 22, when, for example, a service/DHCP server 211 has not been selected in the management server 2, in the DHCP server selection response information, 0.0.0.0 is set instead of the IP address of the DHCP server 211, and a subnet address is unused (undefined value). When the service/DHCP server is not selected, the management server 2 notifies the client machine 1 of 0.0.0.0 instead of the IP address of the DHCP server so that the client machine 1 extends the response waiting of the DHCP server. In this case, the extended PXE client 111 restarts the DHCP Offer waiting timer and waits for a DHCP Offer. The waiting time at this time is, for example, 8 seconds which are equal to a recommended value (second retry) of DHCP.

When the DHCP Offer waiting timer ends, the extended PXE client 111 transmits the DHCP Offer list 1114 to the management server in the same manner as the first time and waits for a response of the management server 2. Therefore, the extended PXE client 111 receives the DHCP Offer until the extended PXE client 111 transmits the DHCP Request, and prepares for an instruction to wait for a DHCP server response from the management server 2.

In the first embodiment, as an example, the time of the DHCP Offer waiting timer is set to 4 seconds in the first time according to a recommended value of the DHCP, and thereafter is set to 8 seconds, 16 seconds, and 32 seconds for each extension. However, this value does not limit the processing of this embodiment and may be set arbitrarily. When there is no DHCP Offer, the extended PXE client 111 may retry the DHCP Discover based on the DHCP specifications. In addition, when the DHCP Offer is received even after the timer expires, the extended PXE client 111 adds information to the DHCP Offer list 1114. The extended PXE client 111 saves the DHCP Offer between the end of the timer and the receipt of an instruction to extend response waiting of the DHCP server. Therefore, when an instruction is received to extend the response waiting of the DHCP server after the timer expires, there is no reception omission of the DHCP Offer.

(1.4) After specifying, for example, the DHCP server 211 selected by the management server 2, the extended PXE client 111 continues the same processing as that of the normal PXE client. That is, after storing the received NBP 213 in, for example, the memory 12A, the extended PXE client 111 notifies the firewall setting information to the firewall setting processing circuit 1012 of the BMC 10. That is, the extended PXE client 111 calls the firewall setting processing circuit 1012 of the BMC 10.

(2) Firewall Setting and Unsetting

(2.1) Firewall Setting

The firewall setting processing circuit 1012 of the BMC 10 receives the firewall setting information from the extended PXE client 111. The received firewall setting information has the configuration described with reference to FIG. 23. The received firewall setting information has an IP address allocated to the client machine 1 and a subnet address notified from the management server 2.

The firewall setting processing circuit 1012 of the BMC 10 sets a value for restricting a communication in the firewall 17 of the client machine 1 based on the received firewall setting information. That is, the firewall setting processing circuit 1012 sets the firewall 17 so as to permit communication according to an IP address allocated by an intended DHCP server and information of the subnet to which the allocated IP address belongs, and prevent communication according to an IP address allocated by an unintended DHCP server and information of the subnet to which the IP address belongs. Since the firewall 17 used here has general functions and operation methods, the detailed setting method will be omitted.

After the above setting, the firewall 17 performs the following setting for a DHCP message (Discover or Request) transmitted from the client machine 1. First, the firewall 17 releases a broadcast flag of the DHCP message. In addition, the firewall 17 sets the IP address of the intended DHCP server as the transmission destination IP address of an IP packet. That is, the broadcast packet is a packet whose reception destination IP address is 255.255.255.255. For example, the firewall 17 sets the reception destination IP address of the broadcast packet as the IP address of the DHCP server 211A. According to this setting, the broadcast packet passing through the firewall 17 is converted into a unicast packet addressed to the DHCP server 211A. With the above setting, the DHCP message is transmitted only to the intended DHCP server 211A.

(2.2) <Firewall Unsetting>

The firewall setting processing circuit 1012 of the BMC 10 receives the following information, together with a designation of unsetting, from the extended PXE client 111. That is, upon unsetting, the firewall setting processing circuit 1012 of the BMC 10 receives the IP address allocated to the client machine 1 and the subnet address notified from the management server 2.

The firewall setting processing circuit 1012 of the BMC 10 unsets the firewall 17 of the client machine 1 based on the received firewall setting information. According to the unsetting, subsequent DHCP messages may be broadcast.

(3) Processing by Firewall 17

As a result of the selection of, for example, the DHCP server 211 and the setting of the firewall 17, the firewall 17 for limiting the transmission destination of the DHCP message is constructed in the client machine 1. According to the setting of the firewall 17, the firewall 17 transmits the DHCP message from the NBP 213 to the target DHCP server without broadcasting. The purpose of using the restriction by the firewall 17 is to narrow down the transmission destinations without changing the specifications of, for example, the DHCP server 211. Further, the purpose of the above setting is to solve the problems caused by the existence of, for example, plural DHCP servers 211 when the NIC 16 of the client machine 1 acquires the IP address after the NBP 213 normally downloaded to the client machine 1 is activated.

(4) Processing by Management Server 2

(4.1) The management processing circuit 20 receives the DHCP Offer list 1114 in the communication with the client machine 1. Then, the management processing circuit 20 of the management server 2 searches the DHCP selection information stored in the management information 204 of the database for, for example, a service and a subnet to which, for example, each DHCP server 211 belongs. The management processing circuit 20 selects, for example, the DHCP server 211 to be used from the DHCP Offer list 1114 based on the search result from the management information 204 of the database. Then, the management processing circuit 20 transmits the information such as the IP address of, for example, the selected DHCP server 211 and the subnet address to the client machine 1. For example, when the management processing circuit 20 selects the DHCP server 211, the PXE server 21 including the selected DHCP server 211 includes a TFTP server 212 serving as a providing circuit for providing the NBP 213 (program) to the client machine 1. Therefore, it can be said that the management processing circuit 20 of the management server 2 supports the allocation of addresses by the allocation circuit of a server device that provides a program among the plural server devices. Here, the plural server devices are exemplified by, for example, the PXE server 21 including the DHCP server 211 and the TFTP server 212. Further, the allocation circuit is exemplified by the DHCP server 211. Further, the server device serving as the program providing circuit is exemplified by the PXE server 21.

(4.2) The management processing circuit 20 provides an input screen (FIG. 24) to allow the administrator to select, for example, the DHCP server 211. Further, the management processing circuit 20 may select an intended DHCP server 211 from the DHCP Offer list 1114 based on the selection result by the administrator on the input screen (FIG. 25). The management processing circuit 20 searches the database management information 204 for a subnet address to which, for example, the DHCP server 211 selected on the input screen belongs. Then, the management processing circuit 20 transmits the information such as the IP address of, for example, the selected DHCP server 211 and the subnet address to the client machine 1.

(4.3) DHCP Server Pre-Designation on Management Server 2

For example, the administrator accesses the management server 2 by the management terminal 5 and inputs the host name or IP address of the BMC 10 of the target client machine 1 in a DHCP server selection screen for pre-designation (hereinafter referred to as a DHCP server selection screen (pre-designation)) so as to select, for example, a target DHCP server 211. The management server 2 displays a list of, for example, DHCP servers 211 grasped by the management server, together with the following information, on the DHCP server selection screen (pre-designation) exemplified in FIG. 24.

Target service (in other words, information which indicates “a service provided by a DHCP server” and can be retrieved from the DB of the management server); host name (a case where a host name (FQDN (Fully Qualified Domain Name) can be confirmed with, for example, DNS (Domain Name System)); IP address of the DHCP server 211;

The management server 2 stores a combination of, for example, the target client machine 1 and the selected DHCP server 211 as DHCP server selection information in the management server 2.

Upon receiving the DHCP Offer list 1114 from the client machine 1, the management processing circuit 20 of the management server 2 checks whether the DHCP selection information of this client machine 1 exists in the management information 204. The management processing circuit 20 is able to specify the client machine 1 from the transmission source IP address (the host name of the BMC 10) of the DHCP Offer list 1114.

When the DHCP selection information of the client machine 1 exists in the management information 204 and, for example, the DHCP server 211 selected by the DHCP selection information is included in the DHCP Offer list 1114, the management server 2 may select, for example, the corresponding DHCP server 211. That is, the management server 2 selects the IP address of, for example, the corresponding DHCP server 211 and the subnet address to which the DHCP server belongs (searchable from the DB storing the management information 204 in the management server 2). Then, the management server 2 transmits the IP address of, for example, the selected DHCP server 211 and the subnet address to which, for example, the selected DHCP server 211 belongs, to the extended PXE client 111 of the client machine 1. Thereafter, the management server 2 deletes the DHCP selection information of this client machine 1.

When, for example, the selected DHCP server 211 is not included in the DHCP Offer list 1114, the administrator waits for the DHCP Offer from the intended DHCP server or selects an alternative DHCP server. The processing in this case and the setting procedure by the administrator are the same as the DHCP post-selection processing and setting procedure by the administrator in the next item. When the administrator selects the alternative DHCP server, the management server 2 also deletes the DHCP selection information for this client machine 1.

(4.4) DHCP Server Post-Selection on Management Server 2

When the administrator does not designate, for example, the target client machine 1 and the DHCP server 211 of the PXE booting in advance, the management server 2 displays the DHCP server selection screen (post-selection) illustrated in FIG. 25 based on the DHCP Offer list 1114. The management server 2 prompts the administrator to select a DHCP server for using the intended service by the DHCP server selection screen (post-selection). The procedure will be described below.

First, the extended PXE client communication processing circuit 203 of the management server 2 receives the DHCP Offer list 1114 from the client machine 1. As described with reference to FIG. 21, the IP address of the DHCP server is stored in the DHCP Offer list 1114. Therefore, the DHCP selection processing circuit 201 of the management server 2 searches the DB storing the management information 204 in the management server 2 for a service to which each DHCP server included in the DHCP Offer list 1114 belongs. When the DHCP selection processing circuit 201 can confirm a host name (FQDN) with, for example, DNS, the DHCP selection processing circuit 201 also searches for the host name that could be confirmed.

The DHCP selection processing circuit 201 of the management server 2 displays the DHCP server selection screen (post-selection) on the screen of the management server 2 based on the search result. A list of items such as service, host name, and IP address to which, for example, each DHCP server 211 belongs is displayed on the selection screen. The administrator may select a desired item from the displayed list.

The extended PXE client communication processing circuit 203 transmits to the extended PXE client 111 of the client machine 1 the information such as the IP address of, for example, the selected DHCP server 211 and the subnet address to which, for example, the DHCP server 211 belongs. The management server 2 is able to retrieve from the management information 204 the subnet address to which, for example, the DHCP server 211 belongs.

When an option of extension of response waiting is selected on the DHCP server selection screen (post-selection), the extended PXE client communication processing circuit 203 sets 0.0.0.0 instead of the IP address of the selected DHCP server in the DHCP server selection response information (see FIG. 22) and transmits the DHCP selection response information to the extended PXE client 111 of the client machine 1. Since the DHCP selection response information is sufficient as long as it can be determined from the DHCP selection response information that a DHCP server is not selected, other specific values or flags instead of 0.0.0.0 may be set in the DHCP server selection response information.

Since the processes of the BIOS 12B, the operation side device 10A, and the management terminal 5 are the same as those of the BIOS 312B, the operation side device 310A, and the management terminal 305 of the comparative example, explanation thereof will be omitted.

<Processing Sequence>

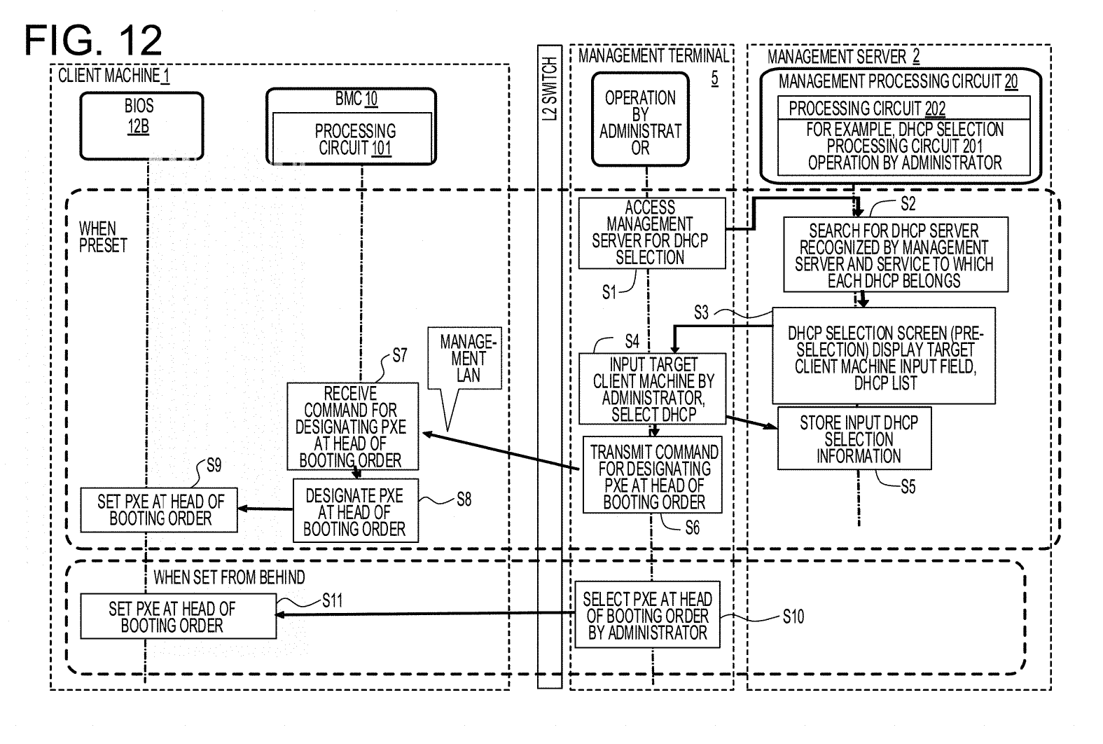

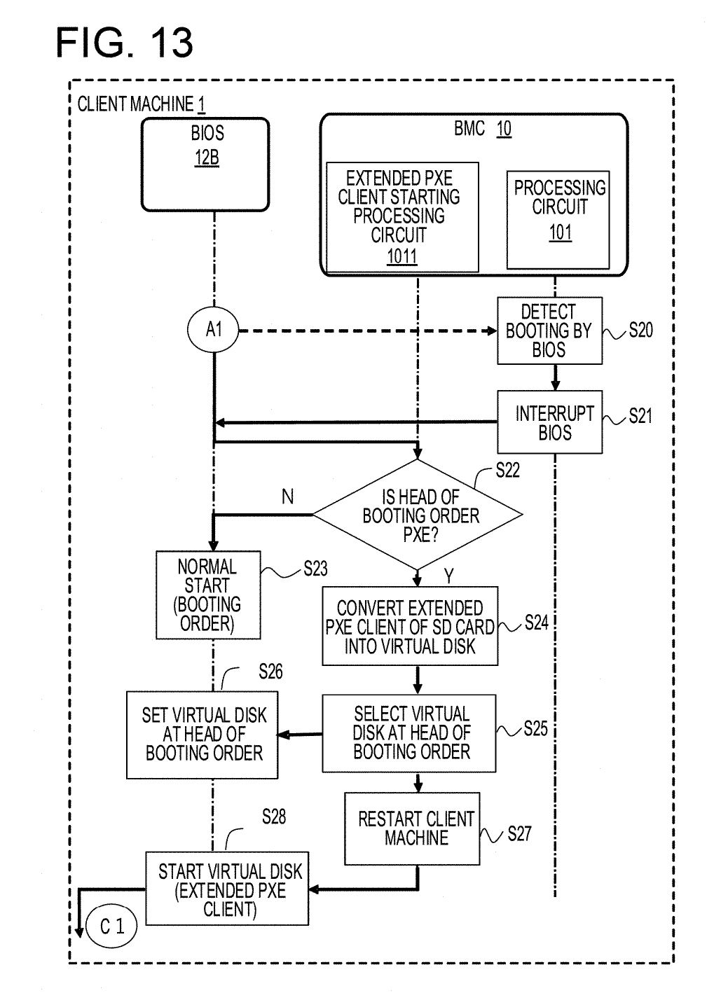

Hereinafter, a processing sequence of the information system 100 according to the first embodiment will be illustrated with reference to FIGS. 12 to 20. FIG. 12 is a sequence diagram illustrating a process of setting PXE at the head of the booting order according to an input operation by the administrator. In FIG. 12, the client machine 1, the management terminal 5, and the management server 2 are arranged in the horizontal direction. Further, in FIG. 12, the time axis is set downward and the sequences by the client machine 1, the management terminal 5, and the management server 2 are sequentially represented from the top to the bottom of the figure. FIG. 12 omits configurations other than the BIOS 12B and the BMC 10 (and its processing circuit 101) in the client machine 1. The management processing circuit 20 and the processing circuit 202 are illustrated in the management server 2. It is assumed that the management server 2 includes, for example, a DHCP selection processing circuit 201. Elements related to the sequence other than those exemplified in FIG. 12, for example, the extended PXE client 111 and the PXE server 21A are exemplified as appropriate in the sequence of FIG. 13 and subsequent figures.

In the process of FIG. 12, first, according to an operation by the administrator, setting for selecting, for example, the DHCP server 211 on the network segment is executed. Therefore, first, the management terminal 5 accesses the management server 2 according to an operation by the administrator (51). Then, according to an operation by the administrator via the management terminal 5, the management server 2 searches for plural DHCP servers 211, 211A and 211B recognized by the management server 2 and a service to which each DHCP server belongs (S2). Here, the service to which each DHCP server belongs refers to a service provided by, for example, the PXE server 21 in which each DHCP server is incorporated. Then, the management server 2 displays the search result on the DHCP selection screen (pre-selection) of the management terminal 5 (S3; see FIG. 24). Here, the pre-selection means that selection is made before the process of PXE booting is started.

The management terminal 5 receives an input from the administrator on the DHCP selection screen (pre-selection) and sets information designating a target client machine in the target client machine input field CL1. Upon receiving the input from the administrator, the management terminal 5 uses the selection field of any row in the DHCP list TB1to select a target service, that is, for example, the DHCP server 211 (S4). Then, the management server 2 stores the inputted service, that is, the information indicated in the relevant row of, for example, the DHCP server 211, as selection information, together with a host name or IP address identifying the target client machine 1 (S5).

Meanwhile, the management terminal 5 transmits a command for designating PXE at the head of the booting order of the client machine 1 to the BMC 10 via the NIC 16-1 of the management LAN (S6). Then, the BMC 10 of the client machine 1 receives the command for designating PXE at the head of the booting order via the NIC 16-1 of the management LAN (S7). Then, the BMC 10 instructs the BIOS 12B to designate PXE at the head of the booting order (S8). In accordance with the instruction from the BMC 10, the BIOS 12B sets PXE at the head of the booting order (S9). In the client machine 1, setting PXE at the head of the booting order may be executed in response to an input from the administrator at a different opportunity from DHCP selection at the management server 2 (S10 and S11).

Thereafter, PXE booting is initiated by starting or restarting (stopping and power-on or resetting) the client machine 1. However, since the power-on procedure by the administrator in the client machine 1 is the same as that in the comparative example illustrated in FIG. 3, explanation thereof will be omitted. In the first embodiment, the process continuing to the symbol Al in FIG. 3 is exemplified in FIG. 13 and the subsequent figures.

When the client machine 1 is powered on, the BIOS 12B tries to start the client machine 1 according to the booting order (the priority order of devices used for starting). At this time, the BMC 10 detects the starting process by the BIOS 12B (S20). Then, the BMC 10 interrupts the BIOS 12B (S21) and executes a process by the extended PXE client starting processing circuit 1011.

In the interruption process, the extended PXE client starting processing circuit 1011 determines whether or not the head (highest priority device) of the booting order set in the BIOS 12B is PXE (S22). When it is determined that the head of the booting order is other than PXE, the extended PXE client starting processing circuit 1011 returns the process to the BIOS 12B and continues the normal starting according to the booting order (S23). Meanwhile, when it is determined that the head of the booting order is PXE, the extended PXE client starting processing circuit 1011 performs the following process in order to start the extended PXE client.

(1) The extended PXE client starting processing circuit 1011 converts the storage area of the program file 111P in the execution form of the extended PXE client stored in the external storage device 13C (e.g., SD card) into a virtual disk (S24).

(2) The extended PXE client starting processing circuit 1011 selects the virtual disk as a designation of the head of the booting order, and instructs the BIOS 12B (S25). Then, the BIOS 12B sets the virtual disk as the designation of the head of the booting order (S26).

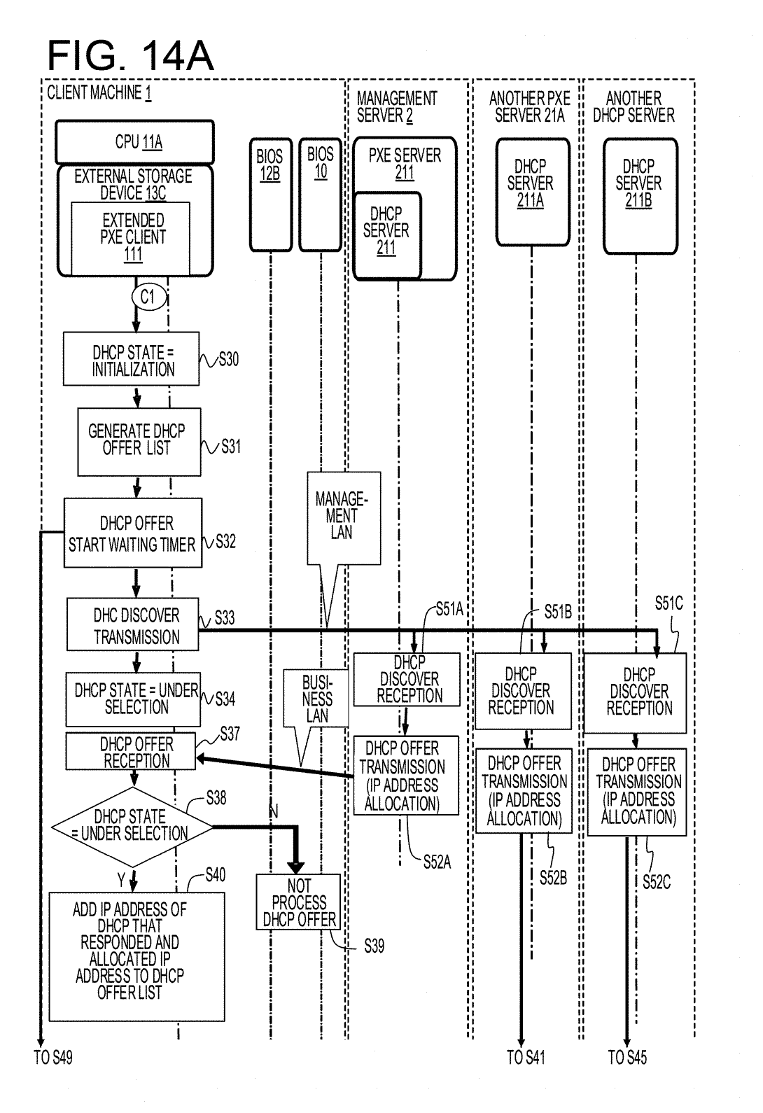

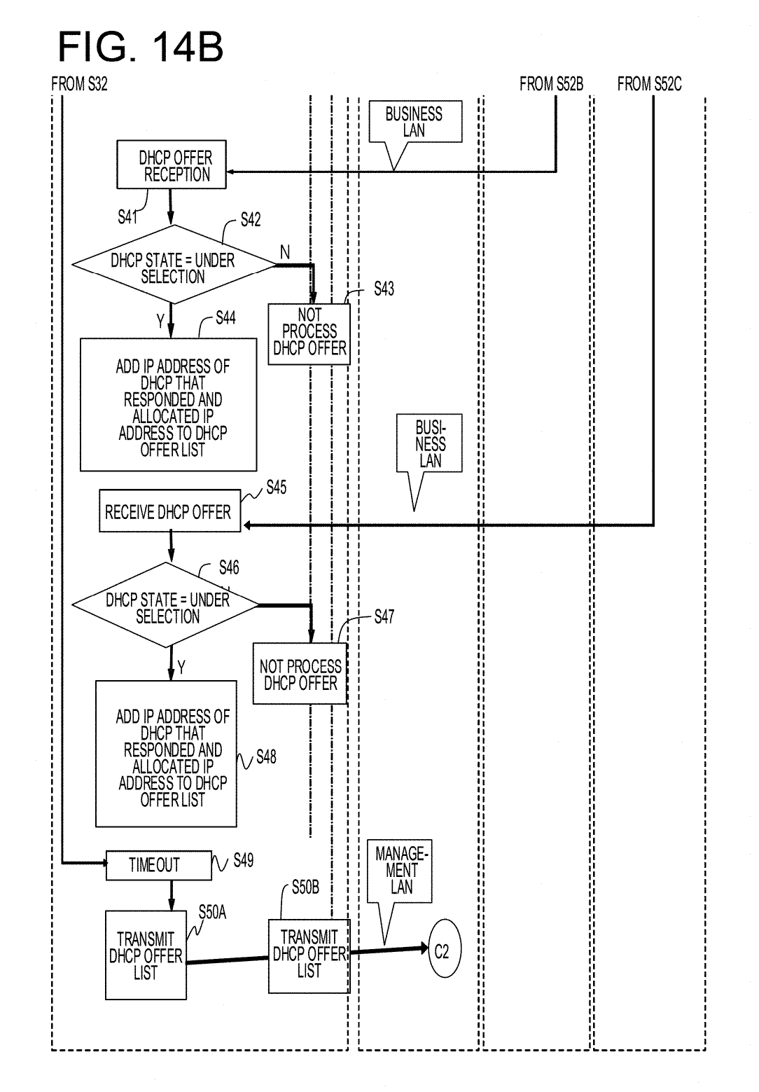

(3) The extended PXE client starting processing circuit 1011 restarts the client machine 1 (S27). Then, the BIOS 12B initiates the restarting with the virtual disk in which the extended PXE client is stored (S28). Thereafter, the sequence of FIGS. 14A and 14B which continues to the symbol Cl is executed.

In FIGS. 14A and 14B, as a sequence continuing to the symbol Cl, the client machine 1 is started by PXE booting. That is, the CPU 11A of the client machine 1 starts the extended PXE client 111 by the BIOS 12B. When the extended PXE client 111 is started by the BIOS 12B, the extended PXE client 111 sets the state of “initialization” in the DHCP state register (S30), similarly to the PXE client 318 of the NIC 316 of the comparative example. Next, the extended PXE client 111 generates an empty DHCP Offer list 1114 (S31).

Next, the extended PXE client 111 starts the DHCP Offer waiting timer (S32). Then, the extended PXE client 111 broadcasts the DHCP Discover via, for example, the NIC 316-2 (S33). The extended PXE client 111 uses the NIC16-2 of the business LAN for communication such as broadcast. That is, the DHCP Discover is broadcast from the NIC 16-2 to which an IP address is to be assigned, and the IP address is notified by receiving the DHCP Offer in the NIC 16-2. Further, the extended PXE client 111 sets the state of “under selection” in the DHCP state register (S34). The process of S33 is an example of requesting allocation of addresses to allocation circuits of plural server devices.

Hereinafter, the extended PXE client 111 executes a process of accumulating DHCP Offers in the DHCP Offer list 1114 after S37 until the DHCP Offer waiting timer set in S32 times out.

When the DHCP Discover is received (S51A, S51B, and S51C), the DHCP server 211 of the management server 2, the DHCP server 211A of the PXE server 21A, and the DHCP server 211B allocate IP addresses to the NIC 16-2 of the client machine 1, respectively, and transmit the DHCP Offer to the extended PXE client 111 using the media access control (MAC) address of the NIC 16-2 of the business LAN via the NIC 16-2 of the business LAN (S52A, S52B, and S52C).

When the DHCP Offer including the allocated IP address via the NIC 16-2 is received (S37, S41, and S45), the extended PXE client 111 determines whether or not the state register is in the “under selection” state (S38, S42, and S46). When it is determined that the state register is in the “under selection” state, the extended PXE client 111 acquires from the DHCP Offer the IP address of, for example, the DHCP server 211 that responded and the IP address assigned to itself by, for example, the DHCP server 211. Then, the extended PXE client 111 adds the acquired IP address of the DHCP server and the acquired IP address assigned to itself to the DHCP Offer list 1114 (S40, S44, and S48). The process of S37 to S40, S41 to S44, and S45 to S48 by the extended PXE client 111 is an example of receiving and acquiring an address allocated by each of plural allocation circuits of plurality server devices.

Meanwhile, when it is determined that the state register is not in the “under selection” state, the extended PXE client 111 does not process the DHCP Offer and waits for the next DHCP Offer (S39, S43, and S47). When the next DHCP Offer is received, the extended PXE client 111 repeats the process of S37 to S40, S41 to S44, and S45 to S48. The process of S32, S40, S44, and S48 is an example of receiving responses from allocation circuits of plural server devices for a predetermined period after requesting allocation, and generating the response list.

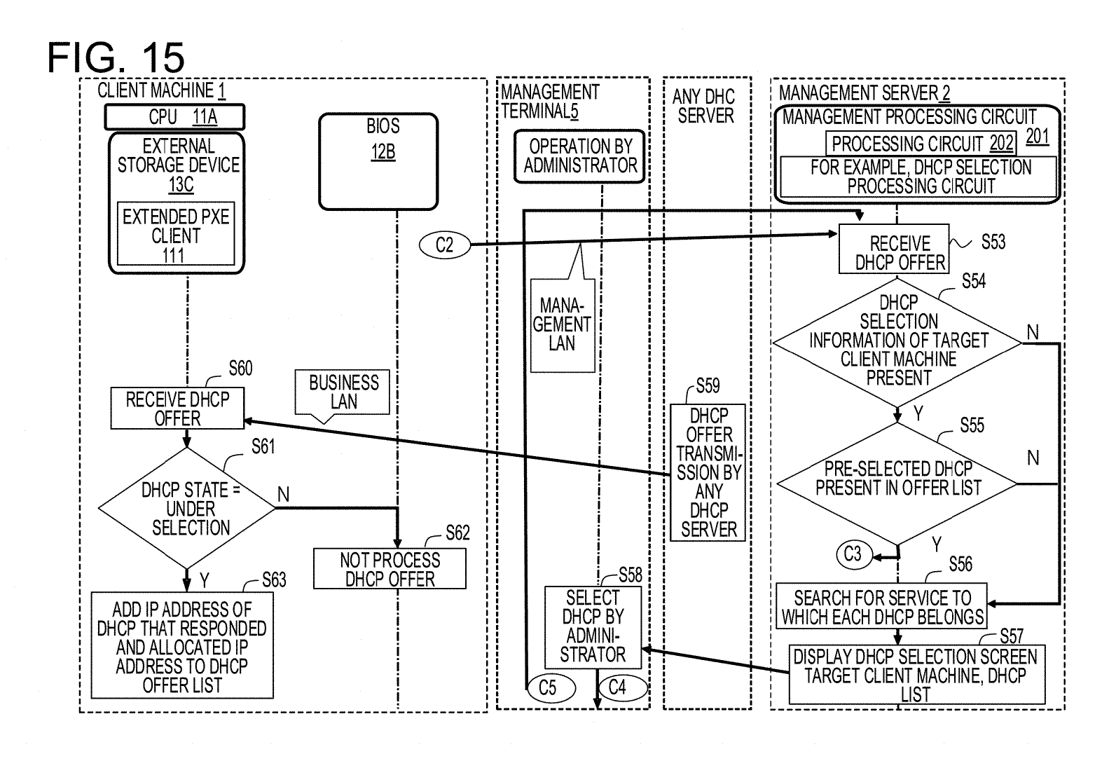

However, when the DHCP Offer waiting timer set in S32 times out (S49), the extended PXE client 111 transmits the DHCP Offer list 1114 to the management server 2 via the BMC 10 (S50A and S50B). The reason for the transmission of the DHCP Offer list 1114 via the BMC 10 is that the IP address of the NIC 16-2 of the business LAN has not yet been determined. The DHCP Offer list 1114 is an example of a response list. Therefore, the process of S50A and S50B is an example of generating list information in which an acquired address is associated with identification information for identifying an allocation circuit of the acquisition destination and outputting the list information to a support apparatus. Thereafter, the sequence continues to FIG. 15 with the symbol C2.

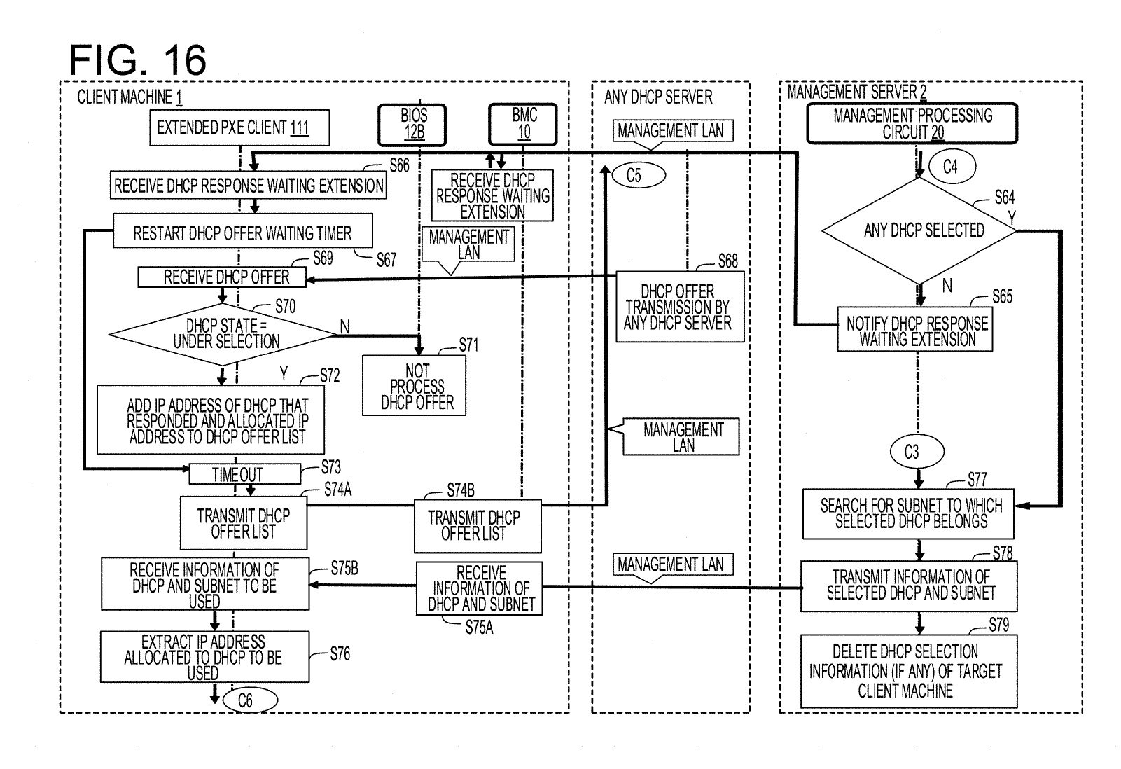

In FIG. 15, when the DHCP Offer list 1114 is received (S53), the processing circuit 202 of the management server 2 determines whether or not DHCP selection information is stored for the target client machine 1 that transmitted the DHCP Offer list 1114 (S54). Here, the DHCP selection information is saved in the management server 2 by, for example, the process of S1 to S5 in FIG. 12. When it is determined that the DHCP selection information is stored, it is determined whether or not, for example, the DHCP server 211 pre-selected in the DHCP selection information is present in the DHCP Offer list 1114 (S55). When it is determined that, for example, the DHCP server 211 pre-selected in the DHCP selection information is present in the DHCP Offer list 1114, the management server 2 advances the process to the sequence continuing to the symbol C3 in FIG. 16.

Meanwhile, when it is determined in S54 that the DHCP selection information is not stored, or when it is determined in S55 that, for example, the DHCP server 211 pre-selected is not present in the DHCP Offer list 1114, the management server 2 searches for a service to which each DHCP server 211 or the like belongs (S56). The service to which, for example, the DHCP server 211 belongs is as described in the process of S2 in FIG. 12. Then, the management server 2 displays the DHCP server selection screen (post-selection) based on the search result (S57). When the administrator selects a DHCP server on the DHCP server selection screen (post-selection) (S58), the sequence continues to the process S64 by the management server 2 of FIG. 16 with the symbol C4. For example, the DHCP server 211 is an example of an allocation circuit, and the process of S54 to S57 is an example of selecting an allocation circuit of one server device based on the selection information from the allocation circuit of the server device included in the received list information.

In the sequence continuing to the symbol C4 in FIG. 16, the management processing circuit 20 of the management server 2 determines whether or not any of the DHCP servers has been selected (S64). When it is determined in S64 that none of the DHCP servers has been selected, an instruction to extend the DHCP response waiting is transmitted to the client machine 1. For example, when the administrator selects a row of “wait for a response of DHCP server” on the DHCP server selection screen (post-selection) illustrated in FIG. 25, the management processing circuit 20 of the management server 2 notifies the instruction to extend the DHCP response waiting to the client machine 1 (S65). The DHCP response waiting extension is notified with the DHCP server selection response information in which 0.0.0.0 is designated instead of the DHCP server IP address in FIG. 22. When the answer in S55 is NO and when the answer in S64 is NO, this is an example of a case in which the support apparatus cannot select an allocation circuit of an intended server device from the list information. The process of S65 is an example of requesting extension of a predetermined period.

Then, the extended PXE client 111 of the client machine 1 receives the instruction to extend the DHCP response waiting (S66) and restarts the DHCP Offer waiting timer (S67). Then, when, for example, one of the DHCP servers 211 transmits the DHCP Offer using the MAC address via the NIC 16-2 of the business LAN (S68), the extended PXE client 111 receives the DHCP Offer (S69). Even before the DHCP response waiting extension, when, for example, one of the DHCP servers 211 transmits the DHCP Offer via the NIC 16-2 of the business LAN (S59), the extended PXE client 111 receives the DHCP Offer (S60).

After receiving the DHCP Offer, the extended PXE client 111 determines whether or not the DHCP state register has been set to “selection waiting” (S61 and S70). Then, when it is determined that the DHCP state register is in the “under selection” state, the extended PXE client 111 acquires from the DHCP Offer the IP address of the DHCP server 211 which has responded and the IP address allocated to itself by the DHCP server 211. Then, the extended PXE client 111 adds the acquired IP address of, for example, the DHCP server 211 and the acquired IP address assigned to itself to the DHCP Offer list 1114 (S63 and S72). The process of S67 and S72 is an example where a processing circuit waits for a response from allocation circuits of plural server devices for a predetermined period after requesting allocation, and generates list information based on the received result.

Meanwhile, when it is determined that the state register is not in the “under selection” state, the extended PXE client 111 does not process the DHCP Offer and waits for the next DHCP Offer (S62 and S71).

Then, when the DHCP Offer waiting timer set in S67 times out (S73), the extended PXE client 111 transmits the DHCP Offer list 1114 to the management server 2 via the BMC 10 and the NIC 16-1 of the management LAN (S74A and S74B). Thereafter, the sequence returns to S53 of FIG. 15 with the symbol C5.

Meanwhile, when it is determined that, for example, the DHCP server 211 pre-selected in S55 of FIG. 15 is present in the DHCP Offer list 1114, in the process continuing to C3 in FIG. 16, the management processing circuit 20 of the management server 2 searches the database of the management server 2 for a subnet address to which the selected DHCP server belongs (S77). When it is determined in S55 of FIG. 15 that, for example, the DHCP server 211 preselected is not present in the DHCP Offer list 1114 (NO in S55), in a case where the administrator selects one of the DHCP servers, the management processing circuit 20 of the management server 2 searches for the subnet address to which the selected DHCP server belongs. Here, when the answer in S55 is NO and when the answer in S64 is YES, this corresponds to a case where there is no response from a DHCP server assumed by the administrator, but since there is a redundant alternative server, the administrator selects the alternative server.

Then, the management processing circuit 20 transmits information on the IP address and the subnet address of, for example, the selected DHCP server 211 to the client machine 1 via the BMC 10 and the NIC 16-1 of the management LAN (S78). Then, the management processing circuit 20 deletes DHCP selection information (if any) of the target client machine 1 set in advance (S79). The process of S53 to S57, S64, and S77 to S78 is an example where a support apparatus selects an allocation circuit of one server device based on the selection information from the allocation circuit of the server device included in the received DHCP Offer list 1114 (an example of list information) and notifies specific information for specifying the selected allocation circuit to the information processing apparatus. Here, the specific information includes network identification information for identifying a network in which an address allocated by the selected allocation circuit is used. The subnet address to which the DHCP server belongs is an example of network identification information for identifying a network in which an address allocated by the selected allocation circuit is used.

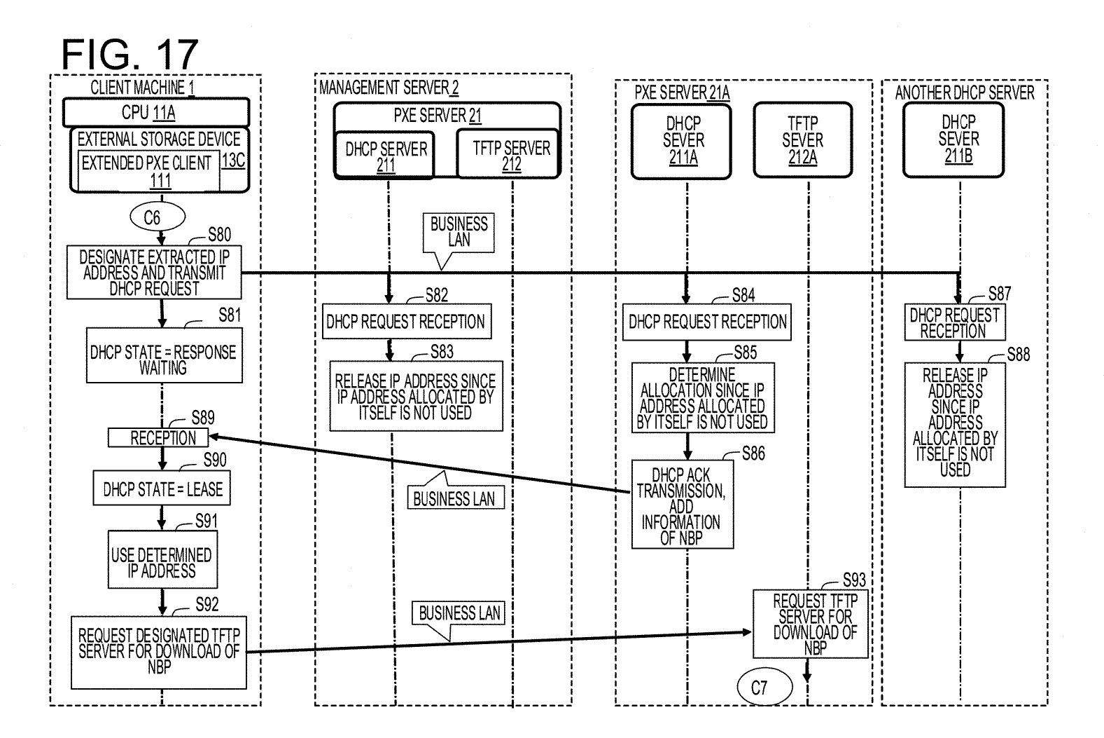

In addition, the extended PXE client 111 is transmitted from the management server 2 by the process of S78, and receives the information of the IP address and subnet address of, for example, the DHCP server 211 to be used via the BMC 10 and the NIC 16-1 of the management LAN (S75A and S75B). Then, based on the received information, the extended PXE client 111 extracts from the DHCP Offer list 1114 the IP address assigned to itself by the intended DHCP server 211 (S76). Here, the IP address allocated to itself is originally an IP address allocated to DHCP Discover by, for example, each DHCP server 211 from the extended PXE client 111. That is, the IP address assigned to the DHCP Discover is an IP address of, for example, the DHCP server 211 described in the DHCP Offer list 1114 and selected by the process of the management processing circuit 20 of the management server 2. Thereafter, the sequence continues to a process S80 by the client machine 1 of FIG. 17 with the symbol C6.

In the sequence continuing to the symbol C6 in FIG. 17, the extended PXE client 111 designates the extracted IP address and broadcasts the DHCP Request via the NIC 16-2 of the business LAN (S80).

It is now assumed that the selected DHCP server is the DHCP server 211A that belongs to the PXE server 21A. This assumption is continued throughout the first embodiment. Then, since the IP address allocated by itself is not used in the received DHCP Request (S82 and S87), the DHCP server 211 and the DHCP server 211B of the management server 2 release the allocated IP address (S83 and S88).

Meanwhile, when the DHCP server 211A of the PXE server 21A receives the DHCP Request (S84), since the IP address allocated by itself is used in the DHCP request, the DHCP server 211A determines the allocation (S85). Then, the DHCP server 211A adds the information of the NBP 213 to the DHCP Ack and transmits the information to the client machine 1 using the MAC address via the NIC 16-2 of the business LAN (S86).

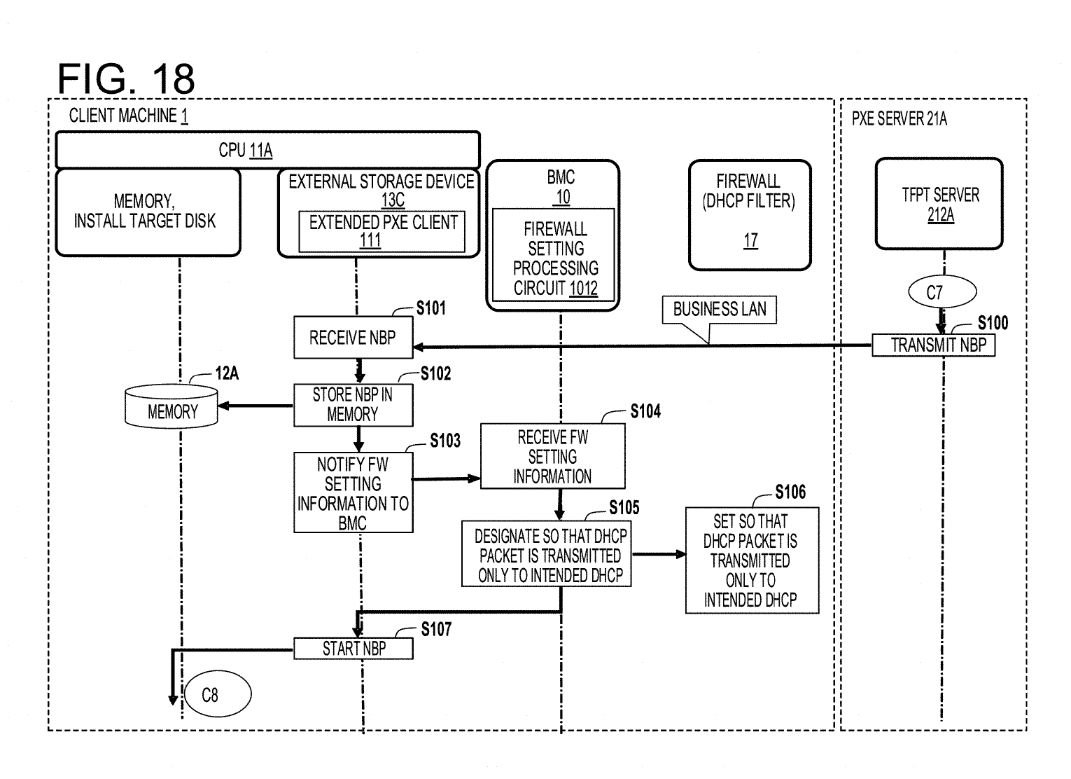

Upon receiving the DHCP Ack (S89), the extended PXE client 111 of the client machine 1 sets the DHCP state register to “lease” (S90). Then, the extended PXE client 111 recognizes the determined IP address as an IP address to be used by itself (S91). The subsequent communication by the client machine 1 is performed using the IP address determined via the NIC 16-2 of the business LAN. Then, the extended PXE client 111 requests the TFTP server 212A designated by the information of the NBP 213A added to the DHCP Ack to download the NBP 213A (S92). Thereafter, the sequence continues to a process S100 by the TFTP server 212A of the PXE server 21A of FIG. 18 with the symbol C7.

In the sequence continuing to the symbol C7 in FIG. 18, the TFTP server 212A transmits the NBP 213A in accordance with a request from the client machine 1 (S100). The extended PXE client 111 of the client machine 1 receives the NBP 213A (S101) and stores it in the memory 12A (S102). Then, the extended PXE client 111 notifies the setting information of the firewall 17 to the BMC 10 (S103). The process of S91, S92 and S101 is an example of receiving a program from a program providing circuit using an address allocated by an allocation circuit designated from a support apparatus. The process of S101 is also an example of receiving a program from a providing circuit provided corresponding to a selected allocation circuit.

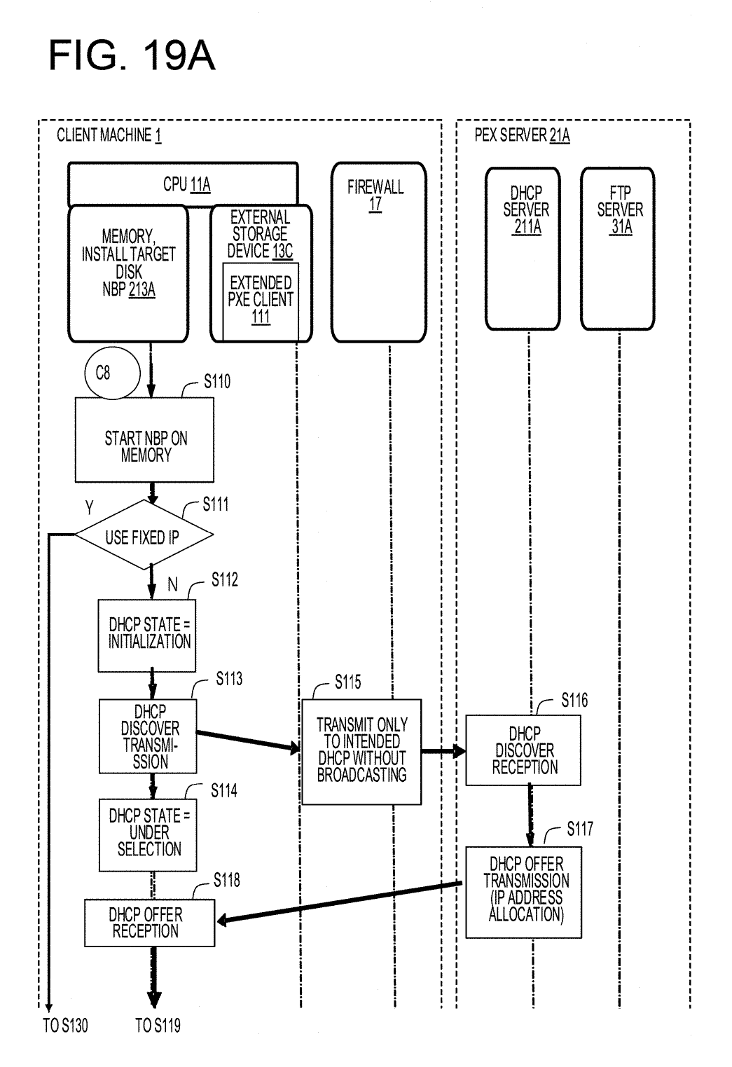

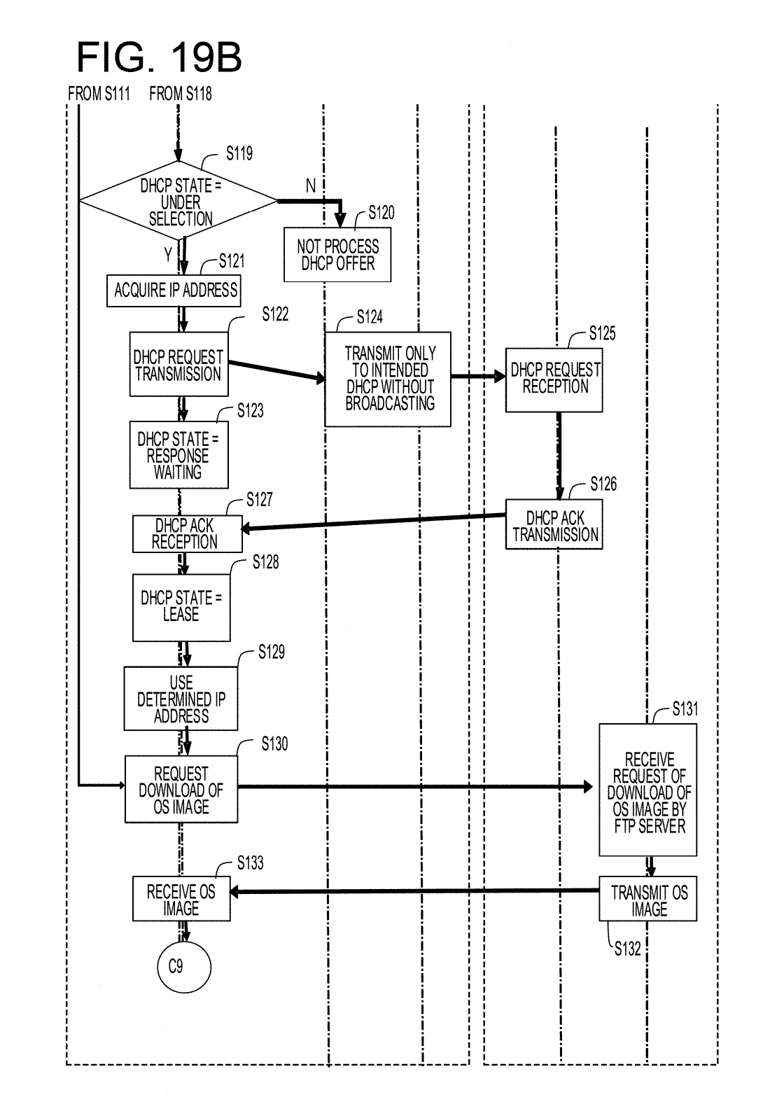

The firewall setting processing circuit 1012 of the BMC 10 receives the setting information of the firewall 17 (S104). Then, the firewall setting processing circuit 1012 designates the firewall so that a DHCP packet is transmitted only to an intended DHCP server 211A (S105). The firewall 17 sets a parameter so that the DHCP packet is transmitted only to the intended DHCP server 211A (S106), and thereafter the firewall operates according to the set parameter, and communication is restricted. Thereafter, in accordance with an instruction from the BMC 10, the extended PXE client 111 starts the NBP 213A stored in the memory 12A (S107). Thereafter, the sequence continues to a process of 5110 by the CPU 11A in FIGS. 19A and 19B with the symbol C8. The process of S106 is an example of allowing a communication control circuit to communicate with an allocation circuit selected only for a network identified by network identification information. The process of S107 is an example of starting a program received by the information processing apparatus.

In the sequence continuing to the symbol C8 in FIGS. 19A and 19B, the CPU 11A starts the NBP 213A on the memory 12A (5110). Thereafter, the CPU 11A executes a process according to the NBP 213A. First, the NBP 213A determines whether to use a fixed IP address (5111). When it is determined that a fixed IP address is not used, the NBP 213A sets the DHCP state register to “initialization” (S112). Then, the NBP 213A broadcasts the DHCP Discover (S113). Then, the NBP 213A sets the state of “under selection” in the DHCP state register (S114).

The firewall 17 rewrites the flag area (see FIG. 27) of the DHCP Discover so that the DHCP Discover from the NBP 213A is not broadcast but is transmitted only to the intended DHCP server 211A. The transmission destination IP address of the broadcast packet whose transmission destination IP address is 255.255.255.255 is changed to the IP address of the intended DHCP server 211A. The obtained unicast packet addressed to the DHCP 211A is transmitted via the NIC 16-2 (S115).

Then, the DHCP Discover rewritten in the firewall 17 is transmitted to the DHCP server 211A of the PXE server 21A. Upon receiving the DHCP Discover (S116), the DHCP server 211A allocates an IP address to the NIC 16-2 and transmits the DHCP Offer to the NBP 213A via the NIC 316-2 (S117).

Upon receiving the DHCP Offer including the allocated IP address (S118), the NBP 213A determines whether or not the state register is in the “under selection” state (S119). When it is determined that the state register is in the “under selection” state, the NBP 213A acquires the IP address from the DHCP Offer (S121) and broadcasts the DHCP Request (S122). Then, the NBP 213A sets the DHCP state register to the “response waiting” state (S123).

The firewall 17 rewrites the flag area (see FIG. 27) of the DHCP Request so that the DHCP Request from the NBP 213A is not broadcast but is transmitted only to the intended DHCP server 211A. The transmission destination IP address of the broadcast packet whose transmission destination IP address is 255.255.255.255 is changed to the IP address of the intended DHCP server 211A. The obtained unicast packet addressed to the DHCP 211A is transmitted via the NIC 16-2 (S124).

Then, the DHCP Request rewritten in the firewall 17 is transmitted to the DHCP server 211A of the PXE server 21A. Upon receiving the DHCP Discover (S125), the DHCP server 211A transmits the DHCP Ack to the NBP 213A via the NIC 16-2 (S126).

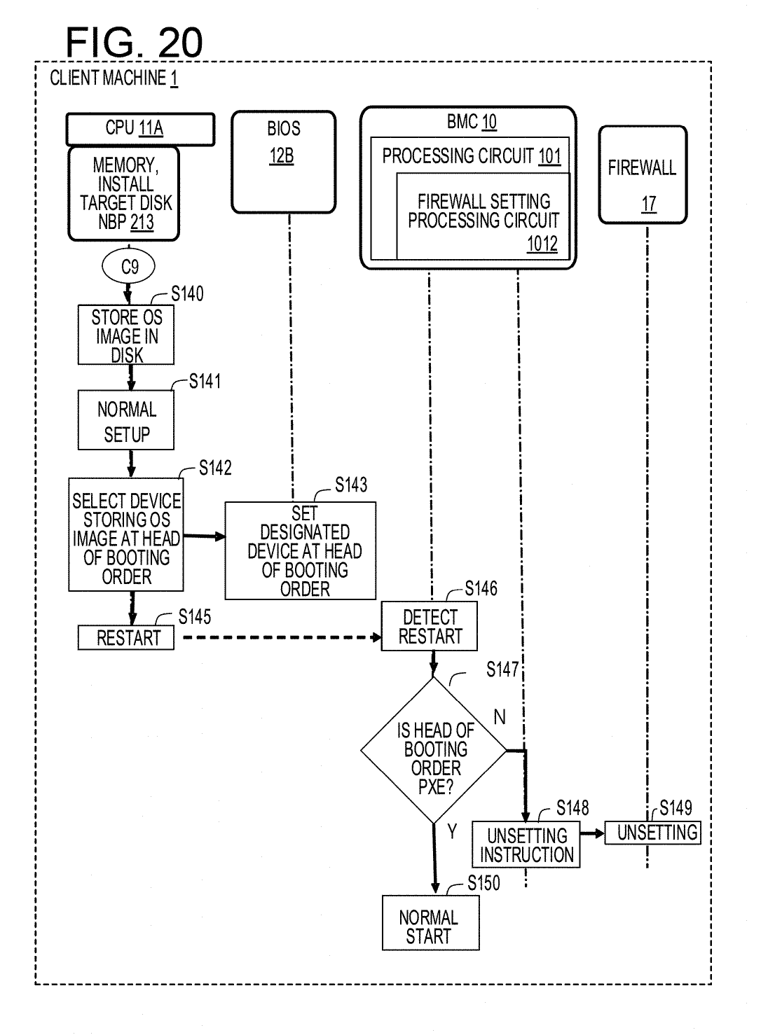

Then, the NBP 213A receives the DHCP Ack (S127) and sets the DHCP state register to the “lease” state (S128). Then, the NBP 213A recognizes the determined IP address as the IP address to be used by itself (S129). Then, the extended PXE client 111 transmits a download request of an OS image to, for example, a predetermined FTP server 31 on the network (S130). Then, the FTP server 31 receives the download request of the OS image (S131) and transmits the OS image (S132). Then, the NBP 213A receives the OS image (S133). Thereafter, the sequence continues to a process S140 by the NBP 213A in FIG. 20 with the symbol C9.

In the sequence continuing to the symbol C9 in FIG. 20, the NBP 213A stores the OS image in the external storage device 13, for example, a hard disk (S140). Then, the NBP 213 performs the normal setup (S141) and instructs the BMC 10 to set a device storing the OS image in S140 at the head of the booting order (S142). The BMC 10 sets a device designated from the CPU 11 at the head of the booting order (S143). Then, the client machine 1 is restarted (S145).

Then, the BMC 10 detects the restart of the client machine 1 (S146) and determines whether or not the head of the booting order is PXE (S147). When it is determined that the head of the booting order is PXE, the firewall setting processing circuit 1012 of the BMC 10 instructs unsetting of the firewall 17 (S148). The firewall 17 is unset and stops the conversion of the DHCP packet and executes the normal communication in the information system 100. When it is determined in S147 that the head of the boot order is not PXE, the BMC 10 instructs the BIOS 12B to perform the normal start.

### Effects of First Embodiment

As described above, in the information system 100 according to the first embodiment, even when there are, for example, plural PXE servers 21 on a network segment, the extended PXE client 111 may be booted by an intended PXE server 21A. That is, the extended PXE client 111 may specify, for example, the PXE server 21A by the pre-set DHCP selection information (see the screen in FIG. 24) saved in the management server 2 or the post-set DHCP selection information (see the screen in FIG. 25). That is, by using the above DHCP selection information, the extended PXE client 111 may determine the DHCP server 211A corresponding to an intended service, the IP address allocated by the DHCP server 211A, and the subnet address corresponding to the IP address of a network in which the DHCP server 211A is used. Therefore, even in the case where plural PXE servers exist in the network segment, in the information system of the first embodiment, as in the comparative example, operational restrictions such as stopping other than the intended PXE server 21A are relaxed.

More specifically, the extended PXE client 111 accumulates the DHCP Offers from, for example, the plural DHCP servers 211 on the network segment due to the existence of, for example, the plural PXE servers 21, makes a list of DHCP Offers, and notifies the list to the management server 2. The management server 2 selects the DHCP server 211A related to the intended PXE server 21A according to the DHCP selection information set in advance or an operation from the administrator executed afterwards. Then, since the management server 2 returns the information including the IP address and the subnet address allocated to the selected DHCP server 211A to the extended PXE client 111, the PXE client 111 may select the PXE server 21A that matches an intended process. Therefore, in the information system 100 of the first embodiment, restrictions such as operating only one of the plural PXE servers on the network segment and stopping other operations may be imposed as less as possible, as discussed in the comparative example.

In the first embodiment, after the PXE server 21A or the DHCP server 211A to be selected is determined and the IP address used by the client machine 1 is determined, the extended PXE client 111 notifies the setting information of DHCP packet conversion by the firewall 17 to the BMC 10. According to this notification, the firewall setting processing circuit 1012 of the BMC 10 designates a parameter in the firewall 17 so that the DHCP packet is transmitted only to the intended DHCP server 211A. Therefore, even when there are plural PXE servers 21 or DHCP servers 211 on the network segment, in the information system 100, the client machine 1 may execute PXE booting without restrictions as in the comparative example.

In addition, in the first embodiment, by inputting the DHCP selection information beforehand or afterwards, the management server 2 may intensively manage the DHCP selection information for a large number of client machines 1 in a network segment. Therefore, by simply transmitting the DHCP Offer list 1114 to the management server 2, the extended PXE client 111 of the client machine 1 may easily determine the IP address allocated by the intended DHCP server 211A and the subnet address corresponding to the IP address used by, for example, the DHCP server 211.

Further, in the first embodiment, when the management server 2 may not select the intended DHCP server 211A (that is, the intended PXE server 21A), the management server 2 transmits the DHCP response waiting extension to the extended PXE client 111. Then, the extended PXE client 111 that received the DHCP response waiting extension restarts the DHCP Offer waiting timer to extend the timer. Therefore, in the first embodiment, even when the DHCP Offer from the intended DHCP server 211A (that is, the intended PXE server 21A) is delayed, there is a higher possibility that the intended DHCP server 211A (that is, the intended PXE server 21A) may be selected, thereby realizing stable PXE booting.

### Modifications

In the first embodiment, OS installation has been exemplified as a process example by PXE booting. However, in the first embodiment, the process by the PXE booting is not limited to the OS installation. That is, in the PXE booting according to the first embodiment, the client machine 1 may execute, for example, firmware update, backup, restoration, and start of a thin client.

### Second Embodiment

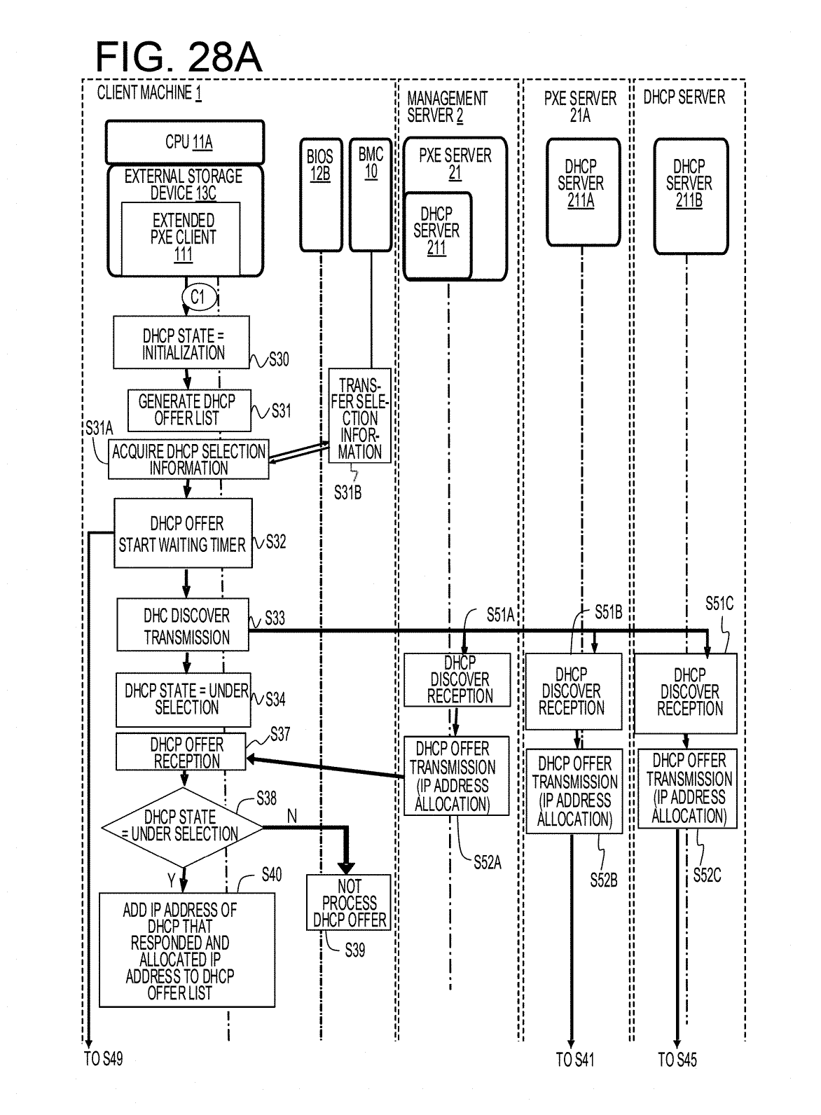

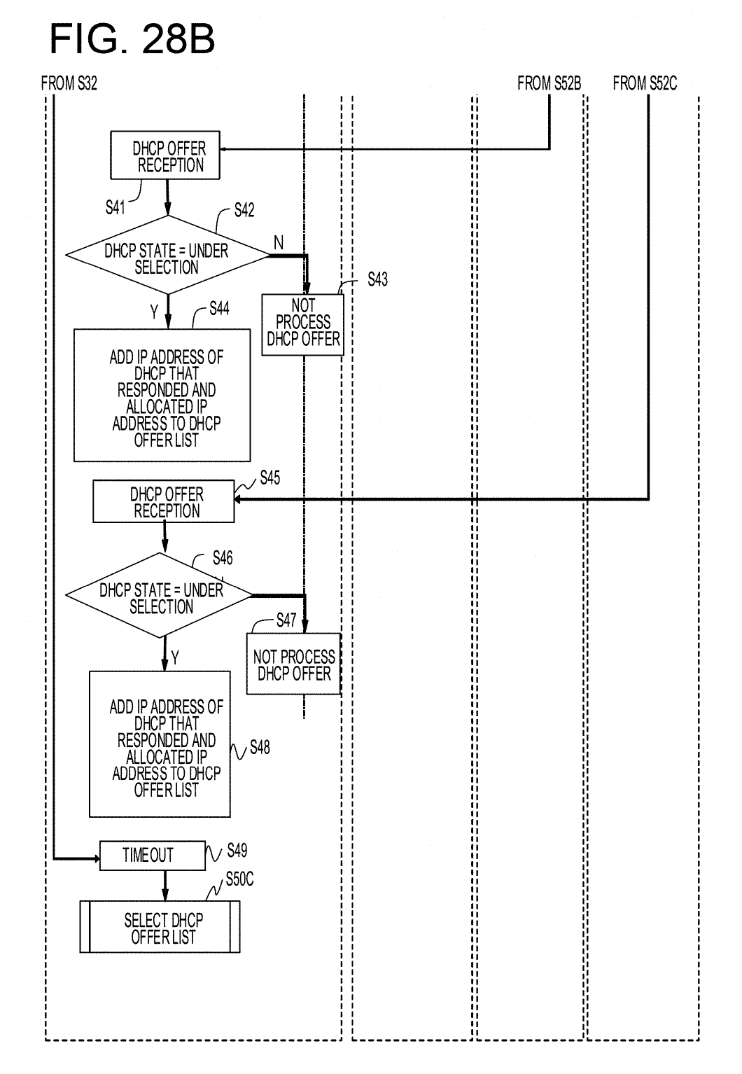

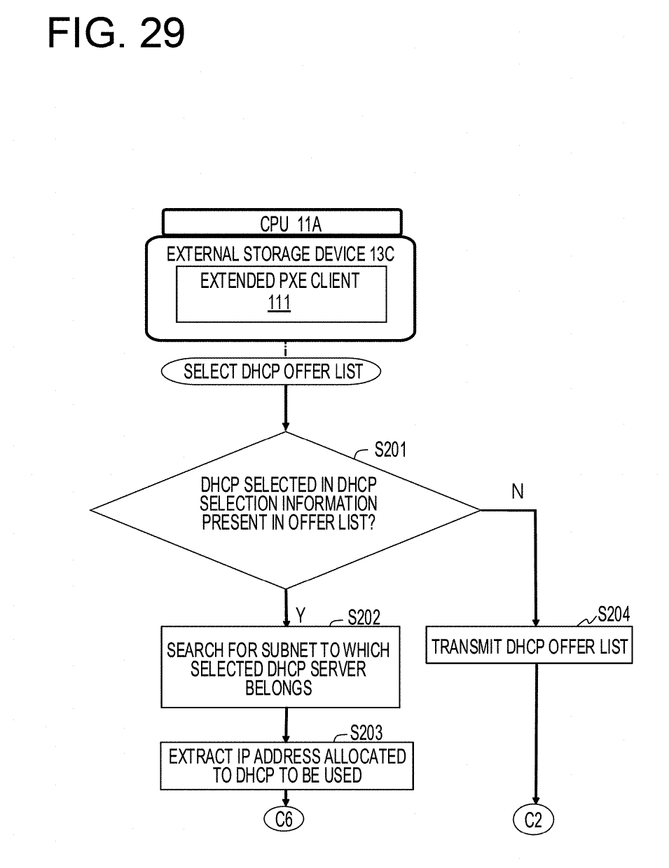

Hereinafter, an information system 100 according to a second embodiment will be described with reference to FIGS. 28A, 28B, and 29. In the first embodiment, plural PXE servers 21 and the like are arranged in the same network segment. Then, when the extended PXE client 111 of each client machine 1 receives the DHCP Offer from, for example, the DHCP server 211 that belongs to, for example, the plural PXE servers 21, the extended PXE client 111 generates the DHCP Offer list 1114 and causes the management server 2 to select the intended DHCP server 211A. In the management server 2, an intended target service and the DHCP server 211A belonging to the intended target service are designated for each client machine 1 in advance through, for example, a DHCP server selection screen (pre-designation).

In the second embodiment, selection information for designating an intended target service and a DHCP server belonging to the intended target service is transferred from the management server 2 to the BMC 10 of each client machine 1. The extended PXE client 111 of each client machine 1 collates the DHCP Offer list 1114 with the selection information held by itself and selects, for example, the DHCP server 211 designated by the selection information. However, as a result of the collation, when the extended PXE client 111 cannot select, for example, the DHCP server 211 designated by the selection information from the DHCP Offer list 1114, as in the first embodiment, the DHCP Offer list 1114 is transmitted to the management server 2. Therefore, since the BMC 10 of the second embodiment is included in the client machine 1, the configuration of the second embodiment is an example of configuration where a support apparatus (BMC 10) and an information processing device (client machine 1) are installed in the same physical apparatus. The other elements and operations of the second embodiment are the same as those of the first embodiment. Therefore, among the elements of the second embodiment, the same elements as those of the first embodiment are denoted by the same reference numerals, and explanation thereof will not be repeated.

FIGS. 28A and 28B are sequence diagrams immediately after the extended PXE client 111 is started in the client machine 1, which is a modification of FIGS. 14A and 14B of the first embodiment. In the second embodiment, when the extended PXE client 111 generates the DHCP Offer list 1114 (S30), it receives the selection information in communication with the BMC 10 (S31A and S31B).

The selection information is information in which the host name or IP address of, for example, the DHCP server 211 corresponding to a target process to be executed is defined in the client machine 1. The client machine 1 may select a DHCP server matching an intended process by collating the DHCP Offer list 1114 collected by the client machine 1 with the DHCP selection information transferred from the BMC 10. The BMC 10 may receive the DHCP selection information in advance from the management server 2 via the NIC 16-1 of the management LAN. Since the DHCP selection information is an example of selection information, in the second embodiment, the BMC 10 may be an example of a management device possessed by the information processing apparatus.

In FIGS. 28A and 28B, the process of S32 to S49 and 551A to S52C is the same as that of FIGS. 14A and 14B of the first embodiment, and therefore, explanation thereof will not be repeated. In the second embodiment, after the DHCP Offer waiting timer times out, the extended PXE client 111 executes selection of the DHCP Offer list 1114 (550C).

FIG. 29 is a sequence diagram illustrating the details of the process of selecting the DHCP Offer list 1114. In this process, the extended PXE client 111 determines whether or not, for example, the DHCP server 211 selected by the DHCP selection information is present in the DHCP Offer list 1114 (S201).

When it is determined that, for example, the DHCP server 211 selected by the DHCP selection information is present in the DHCP Offer list 1114, the extended PXE client 111 searches for a subnet to which, for example, the selected DHCP server 211 belongs (S202). Then, an IP address allocated by, for example, the DHCP server 211 to be used is extracted (S203). The subsequent sequence continues to FIG. 17 of the first embodiment via the symbol C6. In FIG. 17, as in the first embodiment, the extended PXE client 111 may execute a process of broadcasting the DHCP Request with an IP address allocated by, for example, the DHCP 211 to be used and determining the IP address. That is, the process after the symbol C6 is the same as that in the first embodiment.

In the meantime, when it is determined in S201 that the DHCP server 211 selected by the DHCP selection information is not present in the DHCP Offer list 1114, the extended PXE client 111 transmits the DHCP Offer list 1114 to the management server 2 (S204). As in the first embodiment, the management server 2 performs the collimation with the DHCP Offer list 1114, the selection by the DHCP selection screen (post-selection), and, if necessary, the DHCP response waiting extension (request for resetting the DHCP Offer waiting timer). That is, the process after the symbol C2 is the same as that in the first embodiment.

As described above, in the information system 100 according to the second embodiment, the extended PXE client 111 selects the DHCP Offer list 1114. Therefore, when the intended DHCP server designated by the DHCP selection information is included in the DHCP Offer list 1114, the extended PXE client 111 does not have to transmit the DHCP Offer list 1114 to the management server 2. That is, the extended PXE client 111 may determine the intended DHCP server and the IP address allocated to the NIC 16-2 by the intended DHCP server within a range closed by the client machine 1.

In the second embodiment, after the DHCP Offer waiting timer times out, the extended PXE client 111 collates the DHCP Offer list 1114 with the DHCP selection information and selects, for example, the DHCP server 211. However, the second embodiment is not limited to such a procedure. For example, every time the extended PXE client 111 receives the DHCP Offer, it may collate with the DHCP selection information without waiting for the timeout of the DHCP Offer waiting timer. That is, each time the PXE client 111 receives the DHCP Offer, it may determine whether or not it is the IP address allocated by the intended DHCP server. Then, when the IP address designated by the DHCP Offer is the IP address allocated by the intended DHCP server, the extended PXE client 111 may immediately execute the sequence of FIG. 17 after the symbol C6.

[Computer-Readable Recording Medium]

A program that causes a computer or other machine or device (hereinafter collectively referred to as a computer) to implement any one of the above functions may be recorded in a computer-readable recording medium. Then, by causing the computer to read and execute the program of this recording medium, the function thereof may be implemented.

Here, the computer-readable recording medium refers to a recording medium that may accumulate information such as data and programs by electrical, magnetic, optical, mechanical or chemical action and may be read from the computer. Examples of a recording medium that may be detached from the computer may include a flexible disk, a magneto-optical disk, a CD-ROM, a CD-R/W, a DVD, a Blu-ray disk, a DAT, an 8 mm tape, a memory card such as a flash memory, and the like. Examples of a recording medium fixed to the computer may include a hard disk, a ROM (Read Only Memory), and the like. A SSD (Solid State Drive) may be used either as a recording medium that may be detached from the computer or as a recording medium fixed to the computer.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. An information processing apparatus comprising:
a memory; and
a processor coupled to the memory and configured to:
receive a plurality of addresses allocated by a plurality of servers,
receive a program from a designated server among the plurality of servers by using an allocated address of the designated server designated by a support apparatus, and
execute a process to start a received program.

2. The information processing apparatus according to claim 1, wherein the processor is configured to:
generate list information in which the received address is associated with identification information that identifies the server,
output the list information to the support apparatus, and
receive a specific information that specifies the selected server based on selection information from among the plurality of servers included in the list information from the support apparatus.

3. The information processing apparatus according to claim 2,
wherein the specific information includes network identification information that identifies a network in which an address allocated by the selected server is used, and
the processor permits communication with the selected server only in the network identified by the network identification information.

4. The information processing apparatus according to claim 2, wherein the processor is configured to:
request the plurality of servers for allocation of the address,
wait for a response from the plurality of servers for a predetermined period after requesting the allocation, and
generate the list information based on a received result.

5. An information processing apparatus management system, comprising:
an information processing apparatus configured to:
receive an address allocated by each of a plurality of servers,
receive a program from one of the plurality of servers using an address designated by a support apparatus among the addresses allocated by each of the plurality of servers, and
execute a process to start a received program;
the plurality of servers respectively including:
a memory, and
a processor coupled to the memory and configured to:
allocate an address on a network to the information processing apparatus, and
provide a program started by the information processing apparatus to the information processing apparatus to which the address is allocated; and
a support apparatus configured to support allocation of the address of the server that provides a program among the plurality of servers.

6. The information processing apparatus management system according to claim 5,
wherein the information processing apparatus is configured to:
generate list information in which the received address is associated with identification information that identifies the server, and
output the list information to the support apparatus; and
wherein the support apparatus is configured to:
select a server based on selection information from among the plurality of servers included in the list information, and
output specific information that specifies the selected server to the information processing apparatus.

7. The information processing apparatus management system according to claim 6,
wherein the specific information includes network identification information that identifies a network in which an address allocated by the selected allocation circuit is used, and
wherein the information processing apparatus permits communication with the selected server only in the network identified by the network identification information.

8. The information processing apparatus management system according to claim 6,
wherein the information processing apparatus is configured to:
request the plurality of servers for allocation of the address,
wait for a response from the plurality of servers for a predetermined period after requesting the allocation, and
generate the list information based on the received result, and wherein the support apparatus requests extension of the predetermined period when an intended server does not select from the list information in the predetermined period.

9. The information processing apparatus management system according to claim 5,
wherein the support apparatus is coupled to the information processing apparatus via the network.

10. The information processing apparatus management system according to claim 5,
wherein the support apparatus and the information processing apparatus are installed in the same physical apparatus.

11. A non-transitory computer-readable recording medium storing a program that causes a processor included in an information processing apparatus to execute a process, the process comprising:
receiving an address allocated by each of a plurality of servers;
receiving a predetermined program from a server among the plurality of servers by using an allocated address of the server designated by a support apparatus; and
executing a process to start the received predetermined program.

12. The recording medium according to claim 11, wherein the process further includes:
generating list information in which the acquired address is associated with identification information that identifies the server;
outputting the list information to the support apparatus; and
receiving a specific information that specifies a selected server based on selection information from among the plurality of servers included in the list information from the support apparatus.

13. The recording medium according to claim 12,
wherein the specific information includes network identification information that identifies a network in which an address allocated by the selected server is used, and
wherein the processor permits communication with the selected server only in the network identified by the network identification information.

14. The recording medium according to claim 12, wherein the process further includes:
requesting the plurality of server devices for allocation of the address;
waiting for a response from the plurality of servers for a predetermined period after requesting the allocation; and
generating the list information based on a received result.
